(19) United States
(12) Patent Application Publication
(10) Pub. No.: US 2006/0201053 A1
(43) Pub. Date: Sep. 14, 2006

(54) Barrier preventing wood pest access to wooden structures

(76) Inventors: Peter Van Voris, Daniel Island, SC (US); Dominic A. Cataldo, Kennewick, WA (US); Frederick G. Burton, Tooele, UT (US); Henry Leong, Pittsburg, CA (US); Derek Stonich, San Diego, CA (US); Kang-Chi Lin, Lafayette, CA (US); William D. McClellan, Wilmington, DE (US); Kurt W. Bowdle, Greensboro, NC (US); Lorence J. Reed, Callander (CA)

Correspondence Address: Janet M. Garetto;JENKENS & GILCHRIST, A PROFESSIONAL CORPORATION, Ste. 2600, 225 W. Washington, Chicago, IL, 60606-3418, US

(21) Appl. No.: 11/345,899

(22) Filed: Feb. 2, 2006

Related U.S. Application Data
(63) Continuation of application No. 10/005,804, filed on Dec. 3, 2001.
(60) Provisional application No. 60/251,112, filed on Dec. 3, 2000.
(60) Provisional application No. 60/251,141, filed on Dec. 4, 2000.

(51) Int. Cl. A01M 1/24

(52) U.S. Cl. 43/124

(57) ABSTRACT

A multi-layer wood pest barrier having a prolonged lifetime that can be as long as the life of a building or structure to be protected. The lifetime protection is achieved by binding at least one pesticide within a continuous or discontinuous polymer matrix layer thereby substantially reducing release of the pesticide from the matrix. The release rate of the pesticide from the matrix can be controlled by the use of a carrier such as carbon black. The release of the pesticide from the barrier can be further controlled by inclusion of additional layers which can make the barrier substantially non-releasing.

### CROSS REFERENCE TO RELATED APPLICATIONS

This application claims the effective filing date of U.S. Provisional Application Ser. No. 60/251,112 which was filed on Dec. 3, 2000 and U.S. Provisional Application Ser. No. 60/251,141 which was filed on Dec. 4, 2000.

This application also claims the effective filing date of U.S. application Ser. No. 09/353,494 which was filed on Jul. 13, 1999 which is a continuation of U.S. application Ser. No. 09/030,690 which was filed on Feb. 25, 1998 and issued on Nov. 16, 1999 as U.S. Pat. No. 5,985,304.

The disclosures of the aforementioned provisional applications and regular applications are incorporated by reference in their entirety herein.

### FIELD OF INVENTION

The present invention relates to barriers for preventing access by pests (e.g., termites and boring insects) to protected areas and/or structures, such as, homes, buildings and wooden structures for the long-term protection of these areas and/or structures. More particularly, the present invention relates to long-lasting protective barriers and methods which prevent pests from entering protected areas and/or structures, especially areas which contain wooden objects and structures which contain wood. The present invention also relates to methods of making the protective barrier and methods for incorporating them around the areas and/or structures.

### BACKGROUND OF THE INVENTION

Wood which is in contact with concrete, such as in wooden building construction and wood which is in contact with soil for example fence posts, utility poles, railroad cross-ties and wooden supports, can be structurally degraded by the action of one or more wood pests including, but not limited to, termites, ants and other boring insects. Insecticides are available to protect wood from the action of such pests.

Commercial methods which are currently used for controlling pests such as wood boring insects include spraying with insecticides, fumigation with insecticides such as by sealing an entire structure and releasing an insecticide therein, and placing insecticides in spaced discrete locations in the soil beneath the foundation and by treating the soil under the building foundation, before and after construction, with long-residual insecticides in order to repel and/or exterminate insects such as termites. These present commercial methods have a variety of shortcomings.

For example, a common method involves treating the soil underlying the foundation of newly constructed buildings be pre-treated with an insecticide to prevent termite infestation. Insecticide is typically sprayed over and into the soil prior to construction. Because of the lack of communication between pesticide applicator and construction workers, the treated soil often loses its continuity during the construction. Moreover, the currently available soil insecticides tend to lose their biological activity after a period of time to the extent that the treated soil is no longer effective against termite invasion.

The use of insecticides in sprays and fumigation may be damaging to the environment and to human and animal occupants of a home. In addition, significant release of insecticides by spraying and from devices provides the quick release a relatively short lifetime for protection against ingress of pests. Due to the quick release, the insecticides must be repeatedly applied at intervals of from a few days to a few months or a year to remain effective.

Where insecticides are placed in the soil, significant amounts of the insecticides are generally released into the surroundings. Such releases can be harmful to the insecticide applicators, persons who reside at or visit the site of the insecticide application and can be harmful to the environment.

Applying insecticides in a sufficient quantity to be effective over a prolonged period of time is also undesirable. Applying large quantities of insecticides poses ecological and health concerns and may cause unpleasant odors, soil leaching, and volatility of the insecticide. Even where large quantities of insecticide are applied, the insecticides dissipate within a relatively short time and need to be reapplied. Another disadvantage of applying large quantities of insecticide is that the concentration starts out well above the minimum level necessary for effectiveness, decreases rapidly, and drops below the minimal effective level necessary to maintain a barrier within a short period of time relative to the lifetime of the building. Accordingly, established termite colonies in the soil may then invade the structure if additional chemical is not applied beneath and around the structure.

A common method of applying additional insecticide is to introduce it around a building foundation by injection into soil underlying concrete foundations, drenching the soil surrounding the building perimeter, or a combination of both. This type of post-construction treatment is labor-intensive and may not adequately produce a continuous protection.

There is, therefore, a need for providing and maintaining a long-lasting protection for areas and structures such as wooden structures using methods and devices which do not suffer from the aforementioned disadvantages.

### SUMMARY OF THE INVENTION

The present invention provides a multi-layer wood pest barrier having a prolonged lifetime that can be as long as the life of a building or structure to be protected. The lifetime protection is achieved by binding at least one pesticide within a continuous or discontinuous polymer matrix layer thereby substantially reducing release of the pesticide from the matrix. The release rate of the pesticide from the matrix can be controlled by the use of a carrier such as carbon black or gas black. The release of the pesticide from the barrier can be further controlled by inclusion of additional layers which can make the barrier substantially non-releasing.

In addition, the barrier can include layer(s), such as for example, scrim, mesh, sheet, and combinations thereof. The additional layer(s) also may contain one or more pesticides that are the same or different compared to the pesticides in the polymer matrix layer of the multi-layer barrier. The pesticides may be permitted to release from the additional layer(s) for enhanced short term protection.

The barrier and/or additional layer(s) are made with a polymer selected from the group consisting of thermoplastic polymers, thermoset polymers, elastomeric polymers and copolymers thereof. By incorporating the pesticide(s) into the polymers, the pesticide(s) can be held or released at such a rate that they will continue to be effective as toxicants or repellents for insect pests capable of damaging wood structures for a prolonged period of time while at the same time maintaining sufficient concentrations within the barrier to prevent insect penetration through the barrier.

According to one aspect of this invention, there is provided a polymeric-carrier system wherein the pesticide is bound to the carrier as a bound friable mix. A polymeric matrix formed from the mix is made into a thin polymeric sheet or film. The sheet with the bound friable mix is then placed near a wooden structure to provide a barrier that wood pests do not penetrate. An additional layer may provide means for a slow and relatively constant release of the volatile insecticide in order to create a barrier zone beyond the barrier itself in the soil around a wood structure. The polymers include thermoplastic polymers, thermoset polymers, elastomeric polymers as well as copolymers thereof and the insecticide comprises the family of insecticides known as pyrethrins.

According to another aspect of this invention, an exclusion zone is created by placing an extrusion near the wooden structure to be protected. The extrusion has a polymeric delivery system which includes a carrier capable of controlled release of the insecticide. The system maintains a steady and effective concentration of insecticide in the exclusion zone for great lengths of time.

According to another aspect of this invention, a pellet comprising a polymer and insecticide is provided to create and maintain an equilibrium concentration of insecticide for ants, termites and other wood boring insects in an exclusion zone for the wooden structure. The pellet is placed near a wooden structure to treat the soil in order to shield the wooden structure from termites, ants and other boring insects. The pellet can be placed near the structure by a variety of means. Additionally, the pellet can be embedded in a board or even included in a foam. In preferred embodiments, the polymers include thermoplastic polymers, thermoset polymers, elastomeric polymers as well as copolymers thereof and the insecticides are pyrethrins.

According to another aspect of this invention, an exclusion zone is created by injecting a hot melt polymeric mixture. The controlled release device comprises one or more pyrethrins and the polymer is selected from the group consisting of thermoplastic polymer, elastomeric polymers and copolymers thereof.

According to a further aspect of the invention, temperature driven controlled release devices are used to provide the exclusion zones.

According to another aspect of this invention, the controlled release device is used to fumigate structures. It is desirable to place a barrier or create a zone so as to prevent any contact between the wood structure and insects capable of damaging such structures. An exclusion zone is necessary to protect wood structures for extended periods of time.

In a further aspect of the present invention a high density polymer having a low volatility insecticide providing a low release rate of insecticide is combined with a low density (soft) polymer having a more volatile insecticide to provide a reliable exclusion zone.

In accordance with another aspect of the invention, a multi-layer barrier prevents penetration of pests such as crawling wood boring insects and termites into protected areas or structures for a prolonged period of time while avoiding harmful effects on installers of the barrier, persons who visit or occupy the protected areas or structures, and on the environment. The barrier includes an inner active layer (i.e., the pesticide-releasing layer) which contains and releases a pesticide. The barrier also includes two pesticide-retaining layers which allow only minute quantities of the pesticide to release out of the barrier. The inner active layer is sandwiched between the two pesticide-retaining layers such that substantially no pesticide is released from the barrier. One or more additional layers can be included between the pesticide-retaining layers and the pesticide-releasing layer.

In accordance with one aspect of the invention, the barrier comprises a plurality of polymeric layers which are bonded together to form a thin flexible film. The film can be placed to surround areas (such as foundations for houses) which need to be protected from crawling insects such as termites and other pests. In accordance with another aspect of the present invention, the barrier film is pre-shaped off-site to fit in its intended location prior to placing it in its intended location such as in the excavation for the foundation of a house.

In accordance with a further aspect of the present invention, the multi-layer barrier is in form of a thin sheet or film which includes at least one layer which provides strength and puncture resistance to the sheet or film. In accordance with yet another aspect of the present invention, the multi-layer barrier includes outer protective layers which protect the barrier from ultraviolet (UV) rays during installation and when the barrier is exposed to sunlight thereafter.

In accordance with a still further aspect of the present invention, the pesticide is released from the active layer in a controlled manner to help in achieving substantially non-releasing barrier. In other words, the release of only minute amounts of the pesticide from the barrier can be assisted by controlling the release from the active layer.

The present invention also provides efficient methods for making the multi-layer barrier using conventional, commercially available equipment. In accordance with one aspect of the present invention, lamp black or gas black is used in a premix for making the active layer. Lamp black achieves the desired flowability of the premix but unlike a number of other types of carbon black, lamp black does not have detrimental effects on the activity of the pesticide. Lamp black has been found not to deactivate or decompose pesticides.

In accordance with another aspect of the present invention, to make the premix, all or at least a major portion of the carbon black is mixed with polymer particles before adding the pesticide. This approach minimizes detrimental effect of the carbon black on the activity of the pesticide.

In accordance with a further aspect of the present invention, one or more bonding layers are used to secure the layers of the barrier to each other. One advantage of using a bonding layer or layers is that the active layer can be made from a polymer which need not be bondable to the pesticide-retaining layer or additional layers. This allows for the use of active layer polymers which have low melting points. The lower processing temperatures reduce losses of pesticide in the process of making the active layer.

Therefore, in view of the above, it is an object of this invention to provide a barrier or zone of insecticide to protect wooden structures.

It is a further object of the present invention to provide a barrier and an exclusion zone having of a long term low volatility barrier and a high volatility short term barrier to protect adjacent soil.

It is a further object of this invention to maintain a barrier for relatively long periods of time or about 10 to 20 years.

It is a further object of this invention to maintain an exclusion zone for relatively long periods of time of about 10 to 20 years.

The present invention, together with attendant objects and advantages, will be best understood with reference to the detailed description below read in conjunction with the accompanying drawing. Other aspects and advantages of the present invention will become apparent to those skilled in the art upon studying this specification and the appended claims.

### BRIEF DESCRIPTION OF THE DRAWINGS

FIG. 1 illustrates a first embodiment of the invention, comprising spun-bonded polymeric sheeting, and a physical melt-bonded mixture of polymer and insecticide, wherein the mixture of polymer and insecticide is bonded in spots to the polymeric sheeting.

FIG. 2 illustrates a second embodiment of the invention, comprising spun-bonded polymeric sheeting, and a physical melt-bonded mixture of polymer and insecticide, wherein the mixture of polymer and insecticide is bonded in stripes to the polymeric sheeting.

FIG. 3 illustrates a first manner of using the embodiments of the invention shown in FIGS. 1 and 2 and the exclusion zone created by the release of insecticide.

FIG. 4 illustrates a second manner of using the first and second embodiments of the invention to create an exclusion zone.

FIG. 5 illustrates a third manner of using the embodiments of the invention shown in FIGS. 1 and 2 creating an exclusion zone.

FIG. 6 illustrates a third embodiment of the invention, in the form of a cylindrical extrusion.

FIG. 7 illustrates a fourth embodiment of the invention, in the form of a flat strip extrusion.

FIG. 8 illustrates a manner of creating an exclusion zone using the embodiment of the invention shown in FIG. 6.

FIG. 9 illustrates a manner of using the embodiment of the invention shown in FIG. 7 to create an exclusion zone.

FIG. 10 illustrates another embodiment of the invention in the form of pellets wherein the pellets are being inserted into the ground near a wooden structure.

FIG. 11 illustrates a cross-sectional view of pellets placed on a surface.

FIG. 12 illustrates the application of pellets to a concrete structure utilizing foam.

FIG. 13 illustrates a cross-sectional view of a concrete foundation after foam has been applied.

FIG. 14 illustrates pellets set on a board.

FIG. 15 illustrates a board containing pellets being applied to a concrete foundation.

FIG. 16 illustrates a hot-melt injection.

FIG. 17 illustrates the spacing of the hot-melt injection.

FIG. 18 illustrates a plug fumigating cement blocks.

FIG. 19 illustrates a mode of applying plugs to fumigate cement blocks.

FIG. 20 shows a layered device of the present invention.

FIG. 21 is a cross sectional side view showing the layers of a multi-layer barrier made according to another embodiment of the invention.

FIG. 22 is a perspective view of a pre-shaped barrier made of a multi-layer polymeric film in accordance with the present invention.

FIG. 23 is a perspective view of a pre-shaped barrier made of a multi-layer polymeric film in accordance with the present invention.

FIG. 24 is a cross sectional side view showing the layers of a multi-layer barrier made according to another embodiment of the invention.

FIG. 25 shows repellency of Eastern subterranean termites.

FIG. 26 shows repellency of Formosan subterranean termites.

### DETAILED DESCRIPTION OF THE INVENTION

It has been found that a significant reduction or elimination of insects capable of damaging wood structures can be achieved when a barrier alone or in combination with an exclusion zone of insecticide is maintained for a prolonged time in the soil surrounding such structures. An exclusion zone is a zone having a sufficient amount of chemical agent to deter fauna. In the present invention, the chemical agent is a pesticide and the fauna are insects especially boring insects, for example termites and ants. According to one embodiment of the present invention, the insecticide is held in a barrier and/or is released from a controlled release device comprising a polymer matrix system which will last for at least 6 years and often as long as 10 or even 30 years.

It has also been discovered that long-lasting protection from pests can be achieved by sandwiching a pesticide-releasing layer between two substantially non-releasing layers. The substantially non-releasing layers control the release of the pesticide such that only minute amounts of the pesticide release therethrough. These minute amounts of pesticide are sufficient to repel at least most pests and the barrier prevents pests from crossing it. The pesticide is exhausted very slowly and, as a result, the barrier of the present invention can be used to prevent pests from entering a protected area and/or structure for a prolonged period of time, as long as 10 or even 30 years. The use of the layers surrounding the pesticide-releasing layer to substantially prevent the release of the pesticide allows the inner pesticide-releasing layer to release pesticide at a rate that is higher than that of the barrier. This allows the active layer (i.e., the pesticide-releasing layer) to be made using materials and processing conditions that could not be used for making a substantially non-releasing active layer. The release from the pesticide-releasing layer can also be controlled by incorporating a pesticide in a polymer matrix and additional using a carrier such as carbon black (including lamp black and gas black).

As used herein, the term “controlled release device” refers to a device that results in controlled and sustained release of a bioactive chemical to its surface and from its surface into a surrounding medium, for example soil. As used herein, the term “bioactive” means stimulating an organism, usually in a negative way up to and including death for purposes of a deterrent. The term “pesticide” as used herein means and includes any bioactive chemical which controls, repels, reduces and/or prevents pests from penetrating the barrier. A “pest,” as used herein, is meant to include any unwanted plant, animal or microorganism such as arthropods, arachnids, triatomes, insects (such as ants, termites and other wood boring insects), and fungi for example. Included among pesticides are in particular insecticides, herbicides, biocides, e.g. bactericides, viruscides, fungicides and nematicides, and other biological control agents or management materials. The barrier of the present invention is, therefore, intended to be used against all pests which succumb to the lethal and/or repellant properties thereof. The terms “pesticidally effective amount”, “insecticidally effective amount” or “fungicidally effective amount” means the dosage of active substance sufficient to exert the desired pesticidal, insecticidal or fungicidal activity.

In accordance with another aspect of the invention, the device of the present invention provides a method for controlled release of the bioactive chemical into the surrounding environment. The controlled release device releases insecticide at a high rate initially and a lower, steady rate thereafter. Moreover, the initial pesticide can be different from that which is released for a prolonged period of time. This release profile assures that the protected areas and/or structures such as wooden objects or structures containing wood become protected in a relatively short period of time and that, subsequent to reaching the minimum effective level, only the amount of insecticide necessary to replace the degraded insecticide is released. This release profile diminishes potential environmental and health problems of the treatment and reduces the cost of the treatment. The device release rate is dependent only upon the device construction and composition of the device and is independent of external elements such as water.

In accordance with another aspect of the invention, the controlled release device releases the insecticide into the soil at a desired rate to create a zone having the “minimal effective level” of insecticide necessary to prevent insect intrusion. As used herein, the term “minimal effective level” is defined to mean the level of insecticide needed in the zone to prevent insects from entering the zone, the specific level depends on the specific insect and the specific insecticide. When placed adjacent to a foundation or below-grade structural portion, the exclusion zone is created in the soil near the controlled release device. When placed between a non-wood structural portion and an attached wood structural portion, the exclusion zone is created at the interface between the non-wood structural portion and the attached wood structural portion.

When used commercially, the insecticides used generally are approved by a national regulatory body such as the U.S. Environmental Protection Agency (EPA) or other equivalent regulatory body as insecticides suitable to kill or repel termites, ants and other boring insects. The insecticides which are presently preferred for use in the present invention are pyrethrins, including tefluthrin, lambda cyhalothrin, cyfluthrin, and deltamethrin. It will, however, be recognized by those skilled in the art that other effective insecticides such as isofenphos, fenvalerate, cypermethrin, permethrin and natural pyrethrin can also be used. These are available from a number of commercial sources, such as, The Dow Chemical Company, Mobay, Syngenta Crop Protection, Inc., Velsicol and FMC. A combination of insecticides or one or more insecticides in combination with other bioactive ingredients such as fungicides is also in accord with this invention.

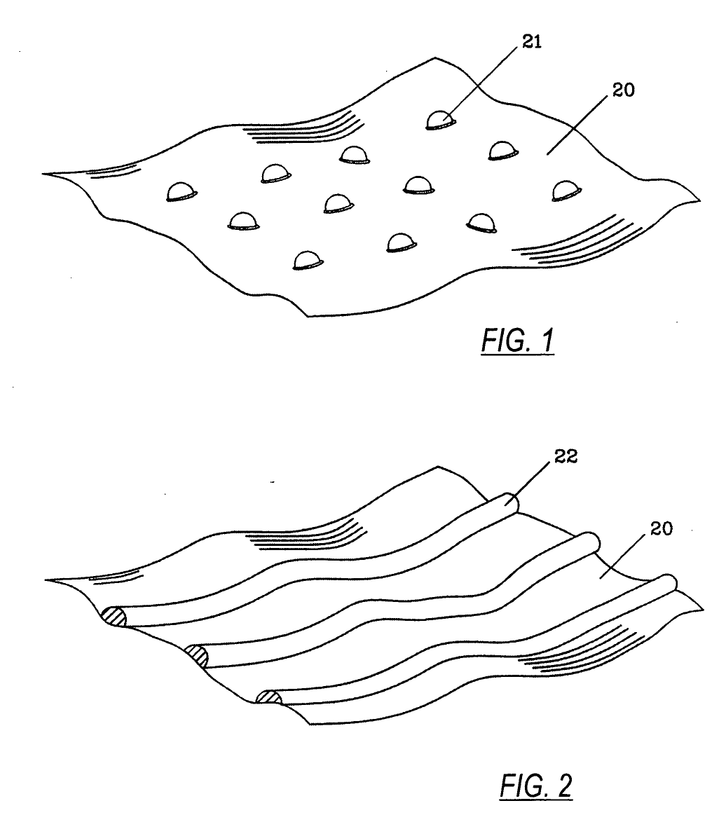

Referring now to the drawings, a first controlled release embodiment of the invention as illustrated in FIG. 1 utilizes a polymeric-carrier device for the controlled release of insecticide to generate an exclusion zone. The embodiment comprises spun-bonded polymeric sheeting 20 and a physical melt-bonded mixture of polymer and insecticide (shown as spots 21 in FIGS. 1 and 3-5). The spun-bonded polymeric sheeting 20 can be either a woven or non-woven textile or it can be a polymeric sheet. Such textiles can be obtained from a number of manufacturers such as Reemay, Exxon Fibers, and Phillips Fibers. Preferably, the textile is woven or non-woven polypropylene.

The polymer in the melt-bonded mixture can comprise any number of thermoplastic polymers, thermoset polymers, elastomeric polymers or copolymers thereof. The selection of the polymers depends upon the desired release rate, the compatibility of the polymer with insecticide and upon environmental conditions. By way of example and not intending to limit the scope of this invention, the following polymers can be used: high density polyethylene, low density polyethylene, vinyl acetate, urethane, polyester, santoprene, silicone, or neoprene. However, the preferred polymers are high density and low density polyethylene. In some embodiments, chlorpyrifos is the preferred pesticide although other pesticides described herein may also be used.

The mixture of polymer and insecticide may be placed on the spun-bonded polymeric sheeting in spots. These spots should be spaced so as to adequately maintain the amount of insecticide above the minimal effective level in an exclusion zone. The minimal effective level is the least amount of insecticide needed in a zone so as to prevent intrusion by insects. Spots 21 in FIGS. 1 and 3-5 are preferably about 0.5 to 1.5 centimeters in diameter, and about 0.5 to 1.5 centimeters in height. The size and shape of the spots will depend upon the user's preference and can be tailored to the job contemplated by the buyer. The spots 21 can be configured in rows with the spacing of the spots preferably being from about 1.5 to 4 centimeters from adjacent spots. It will be recognized by those skilled in the art that other configurations of spots can also be used depending on the particular application. The insecticide releasing polymeric sheet is placed near or around the wooden structure to create an exclusion zone by the controlled release of insecticide.

A second controlled release embodiment of the invention also utilizes a polymeric-carrier delivery system for the controlled release of insecticide comprising spun-bonded polymeric sheeting 20 and a physical melt-bonded mixture of polymer and insecticide. The polymeric sheeting 20 as in the first embodiment can be either woven or non-woven polypropylene upon which is bonded the physical melt-bonded mixture (shown as stripes 22 in FIG. 2). Similarly, the polymers and insecticide described above with respect to the first embodiment may also be used in the embodiment described in this section.

The mixture of polymer and insecticide of the second embodiment may alternatively be placed on spun-bonded polymeric sheeting using extruder systems which provide stripes, e.g., as shown in FIG. 2. The stripes 22 can be about 1 centimeter in height and about 5 to 15 centimeters apart. Optimally, the stripes should be placed about 10 centimeters apart. It is desirable that the stripes should be configured in such an arrangement so as to permit a steady state concentration of insecticide in the exclusion zone after an initial burst of insecticide. After the stripes are applied to the polymeric sheet, the sheet is placed on or near the wooden structure to be protected from insects.

Binding filler and/or carriers may also be included in all of the embodiments of the invention. The inclusion of the binding filler and/or carrier permits greater amounts of insecticide for a given release rate or permits a lower release rate for a given amount of pesticide. The binding carrier binds the pesticide. Binding carriers found to bind the pesticide include carbon based carriers for example carbon black (including lamp black and gas black), activated carbon and combinations thereof. It is believed that alumina, silicoaluminate, hydroxyapatite and combinations thereof may be comparable to carbon for binding bioactive chemicals.

When a carbon based carrier is utilized, the first step is to insure dryness of the carbon followed by mixing the insecticide in a liquid form with the carbon. Only sufficient carbon black (filler) is used to produce a friable mixture. The term “friable” means substantially dry or non-sticky flowable particles. Certain pesticides may have to be heated to achieve a liquid form. The liquid insecticide adheres or binds to the extremely large surface area of the finely divided carbon black and the mixture is cooled for incorporation in the polymer. Polymers which may be used in a carbon application are a polyethylene (including low and high density polyethylene), polypropylene, copolymers or blends of polyethylene and polypropylene, polybutylene, epoxy polymers, polyamides, acrylate-styrene-acrylonitrile, aromatic or unsaturated polyesters, polyurethanes, silicones, or any other suitable polymers or copolymers thereof.

The carbon-insecticide mixture in the first and second embodiments (or just insecticide if carbon is not used) is then mixed with the polymer, preferably polyurethane, in either the molten, powder or liquid stage. Next, this mixture is bonded to the polymeric sheeting. In the first and second embodiments of the invention, the polymer and insecticide are melt-bonded to the polymeric sheeting.

Another mode of bonding the mixture of polymer and insecticide to the polymeric sheeting is by “through-injection molding.” In “through-injection molding”, molten material is injected from a heated nozzle through a porous web and into a mold. The molten material flows through the web under pressure and is solidified in the mold. While the molten material is being injected, the porous web allows air to escape, but it also retains the molten mass under pressure until it has cooled.

A different method of bonding the mixture of polymer and insecticide to the polymeric sheeting is by placing a melted mixture of polymer and insecticide on the spun-bonded polymeric sheeting. If the mixture is melted, it must be allowed to cool, cure and solidify. As used hereinafter, “a melted mixture of polymer and insecticide” is intended to indicate that the polymer is either melted or already in the liquid stage. The insecticide may also be melted or contained in a slurry solution depending on its melting point. A “melted mixture of polymer and insecticide” can also contain carbon or other additives which do not melt but flow with the melted polymer/insecticide mass.

The first and second embodiments of the invention should provide release rates sufficient to maintain an effective insecticide concentration in the exclusion zone to kill or repel insects but at sufficiently slow rates to maintain an effective concentration for an extended period of time.

Overall, a preferred composition for the first and second embodiments of the invention comprises from about 70 to 95 parts by weight of carrier polymer, from about 0 to 15 parts by weight of carbon, and from about 5 to 30 parts by weight of insecticide. The design considerations of the controlled release devices vary according to such factors as user preference and geographic conditions. The steady state release rate of the polymeric delivery system of these two embodiments after the initial burst of insecticide can be maintained for at least 6 years as a barrier to insects such as ants and termites. However, the equilibrium concentration of this embodiment can easily be adjusted to meet the specific needs of each user.

Optionally, the embodiments shown in FIGS. 1-5 may comprise a pesticide-impervious sheet (not shown) such as a metallized foil. The metallized foil or an extruded sheet of a polymer is laminated to one side of the spun-bonded polymeric sheeting in order to direct the flow of insecticide.

A further embodiment of the present invention is a barrier of a pest-impervious sheet wherein a bound friable mix of the bioactive chemical or pesticide with a carbon carrier is placed within a polymer and exhibits substantially no release of the bioactive chemical. The phrases “substantially no release” and “releasing only minute amounts” are intended to define a release rate less than 0.4 μg/cm²/day, preferably less than 0.1 μg/cm²/day, and most preferably less than 0.05 μg/cm²/day. This embodiment encompasses a release rate of below detectable limits. In this embodiment, pests are deterred upon “sniffing” or “scratching” a polymer surface and detecting the presence of the pest harmful bioactive chemical. The lifetime of the barrier is much longer than a barrier with a higher release rate. Moreover, a flaw or tear in the polymer will be less prone to “leak” bioactive chemical. Hence, two or more layers of this embodiment may be preferred to maintain a complete barrier. Multiple layers would permit a tear or hole in one layer, but a pest would not pass a second or subsequent untorn layer. It may further be desirable to place a protective layer, for example scrim, on one or both sides of a barrier layer to avoid tearing.

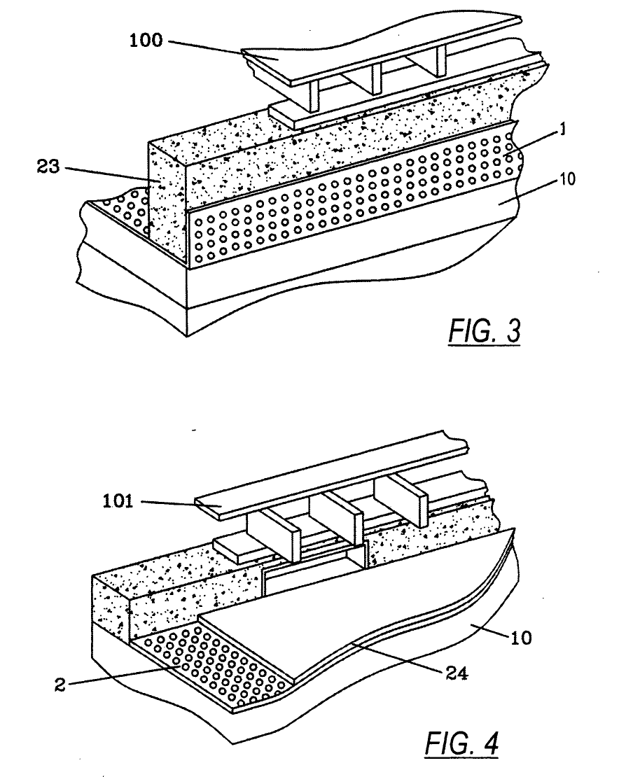

Once made, the polymeric-carrier delivery systems of the first and second embodiments are placed near the structure desired to be protected from insects. FIGS. 3-5 illustrate various applications of either the spotted or striped sheet embodiments of the invention. The FIG. 1 configuration is shown in FIGS. 3-5, but it is understood that the FIG. 2 configuration or other configurations can work as well.

In FIG. 3, the polymeric-carrier delivery system 1 is placed under and alongside a concrete foundation 23 of a wooden structure 100 creating an exclusion zone 10 to protect the structure from termites, ants and other boring insects.

In FIG. 4, the polymeric-carrier delivery system 2 is placed under a structural member 24, such as a porch, patio, sidewalk, or under a basement foundation beside the wooden structure 101 to provide an exclusion zone 10.

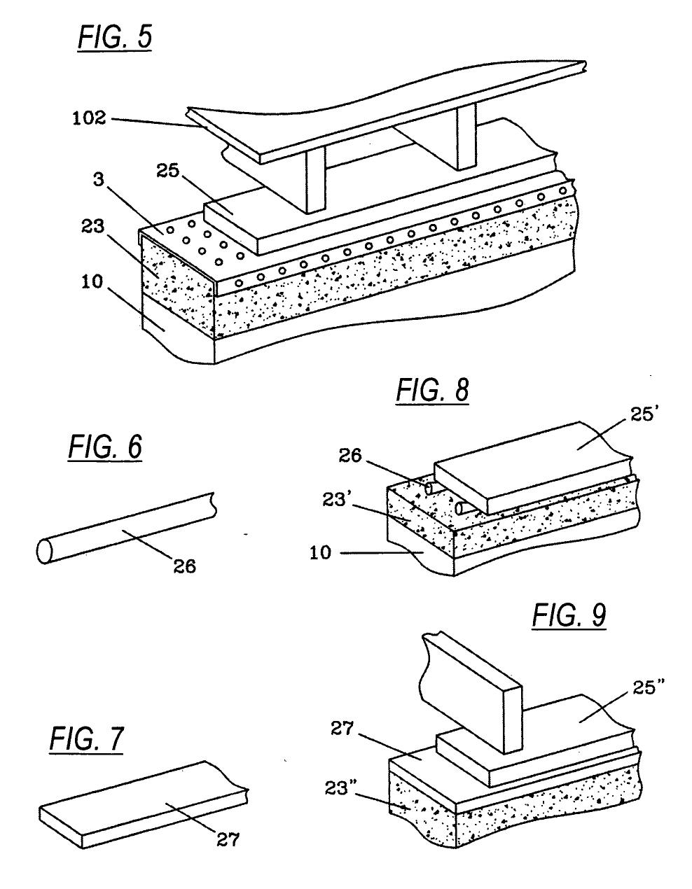

In FIG. 5, the polymeric-carrier delivery system 3 is placed over and on the sides of the concrete foundation 23 of a wooden structure 102, but under the wooden portion 25 of the structure to create an exclusion zone 10.

Another embodiment of the invention is illustrated in FIGS. 6 and 7. This embodiment pertains to extrusions such as extruded flexible cylinders 26 and extruded flexible flat strips 27 shown respectively in FIGS. 6 and 7. A wide variety of polymers which can be classified into four broad subgroups can be utilized. The groups include thermoplastic polymers, thermoset polymers, elastomeric polymers and copolymers of the three groups named above. By way of example, some polymers which can be used from the four groups are high density polyethylene, low density polyethylene, ethyl vinyl acetate (EVA), vinyl acetate, urethane, polyester, santoprene, silicone, neoprene and polyisoprene. In some embodiments, the preferred insecticide is chlorpyrifos although other insecticides described herein can be used. A filler may also be added.

The cylinders preferably have a size ranging from about 5 to 15 millimeters in diameter, but most preferably about 10 millimeters in diameter for the optimal steady state delivery of insecticide into the exclusion zone. Flat strips should preferably have a thickness of from about 1 to 6 millimeters and a width of from about 5 to 15 millimeters. It, however, should be noted that both cylinders and flat strips can be designed to meet the varying conditions encountered by the user.

Overall, in order to maintain an equilibrium concentration of pesticide in the exclusion zone for an extended period of time, the composition of this embodiment of the invention should comprise from about 70 to about 95 parts by weight of polymer, from about 0 to about 30 parts by weight of carbon, and from about 5 to about 30 parts by weight of pesticide. The composition of the extrusion can, however, be tailored to the specific needs of the user. It is estimated that the exclusion zone can be maintained for at least 6 years for a cylinder and likewise for flat strips.

The extrusions can be positioned in a variety of positions to create exclusion zones. FIG. 8 illustrates a manner of using the extrusion shown in FIG. 6. One or more flexible cylinders 26 are placed between the concrete foundation 23′ and the wooden portion 25′ of the structure. The flexible cylinders 26 release insecticide at a controlled rate to create an exclusion zone. An advantage of this configuration is that flexible cylinders 26 can be placed under a structure that has already been built. Similarly, in a manner not shown, the flexible cylinders can be placed vertically into the ground as opposed to horizontally. As will be recognized by those skilled in the art, the extrusions may have other suitable shapes and be placed in any suitable position depending upon the particular use contemplated.

FIG. 9 illustrates a manner of using the flexible flat strip extrusion shown in FIG. 7. One or more flexible flat strips 27 create an exclusion zone by being placed between or alongside the concrete foundation 23″ and the wooden portion 25″ of the structure. The flexible flat strips 27 can also be placed vertically alongside a wall in an embodiment not illustrated in the drawings. Again, any suitable placement of the flat strips is considered as being within the scope of the invention.

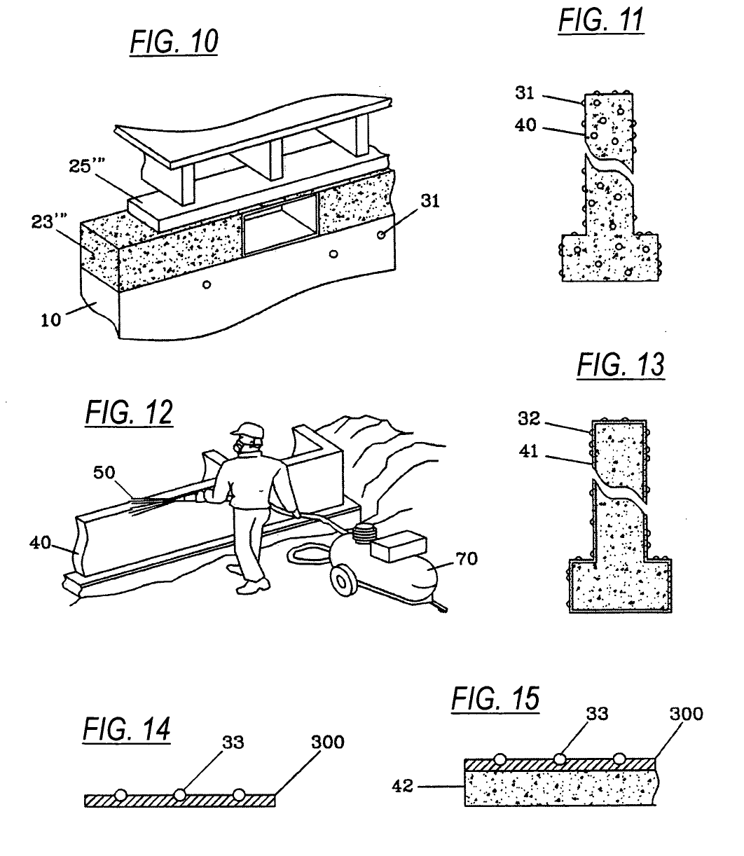

The controlled release of insecticide can also be conveniently achieved by using pellets as illustrated in the embodiments shown in FIGS. 10-13. The pellet 13 comprises polymer, insecticide and preferably also includes a filler. Various polymers can be used in this embodiment. They can comprise polymers of four subgroups consisting of thermoplastic polymers, thermoset polymers, elastomeric polymers and copolymers thereof. Polymer selection from these four subgroups depends upon design considerations with the preferable polymer being either high density polyethylene or low density polyethylene. In turn, the insecticide preferable comprises tefluthrin, but the following insecticides can also be used: isofenphos, fenvalerate, cypermethrin, permethrin and other pyrethrins. For optimal results, a carrier such as carbon can also be incorporated into the mixture.

The pellet 31 releases insecticide at a controlled rate for an extended period of time in order to establish an exclusion zone. The composition for such a pellet needed for the maintenance of a zone in the soil is from about 70 to about 95 parts by weight of polymer, from about 0 to about 30 parts by weight of carbon black, and from about 5 to about 30 parts by weight of insecticide. Ultimately, the compositions of the pellet depend upon user preference.

The pellets can be any convenient size depending upon the intended use, such as 1 to 25 millimeters in diameter (or width and thickness, if rectangular) by 2 to 20 centimeters or more in length. Furthermore, in order to fit specific user needs, the dimension of the pellets and the concentrations of the insecticide can easily be adjusted. However, an exclusion zone can be maintained for at least 6 years.

Additionally, pellets 31 have the advantage that they can be conveniently placed almost anywhere. The pellets of this embodiment of the invention are shown in FIG. 10. A pellet 31 is inserted near a wooden structure 25. The pellets as illustrated in FIG. 10 can be placed under a cement foundation 23′″ or they can be placed directly under the wood structure (not illustrated) so as to permit the creation of a zone 10 surrounding the wooden structure 25′″ to exclude insects capable of damaging such structures. FIG. 11 shows a cross-sectional view of pellets 31 inserted on a surface 40.

Pellets are easily applied to a wide variety of uses. FIG. 12 illustrates pellets sprayed 50 onto a concrete structure surface 40. FIG. 15 illustrates treating a surface by placing pellets 33 on preformed boards 300.

Pellets 32 are applied onto a surface 40 such as soil or concrete via a foam 41 as illustrated in FIG. 13. The pellets are first incorporated into a foam in a manner known in the art. The foam 41 containing the fine pellets is then sprayed 50 as illustrated onto the surface 41 via a motorized sprayer 70 in FIG. 12 so as to provide a protective coating for the surface. The pellets 32 then release the insecticide to create a protective barrier in the soil to protect the wood from harmful insects. For best results, the foam 50 is comprised of polyurethane. It is also possible to use silicone, polyester, or polyvinyl acetate. The pellets 32 can vary in size depending upon the foam thickness and the desired concentration of insecticide in the exclusion zone. The thickness of the foam to be applied to a surface can vary according to the user's preference. The exclusion zone can be maintained for at least 6 years. In addition to being used as a carrier for insecticide, the foam also cures cement and acts as an insulator.

A preformed board with embedded pellets 33 can also be utilized as an embodiment of this invention as illustrated in FIG. 14. This board 300 can be made of any type of material which can suitably hold the pellets 33. Preferably, the board is comprised of styrofoam which is registered as a trademark of The Dow Chemical Company. The board can be applied in any variety of fashions and can also work as an insulating device. One manner of application is illustrated in FIG. 15, where the board 300 with pellets 33 is placed above a concrete surface 42. The embedded pellets are regularly spaced with the spacing being specified by the devised amount of insecticide.

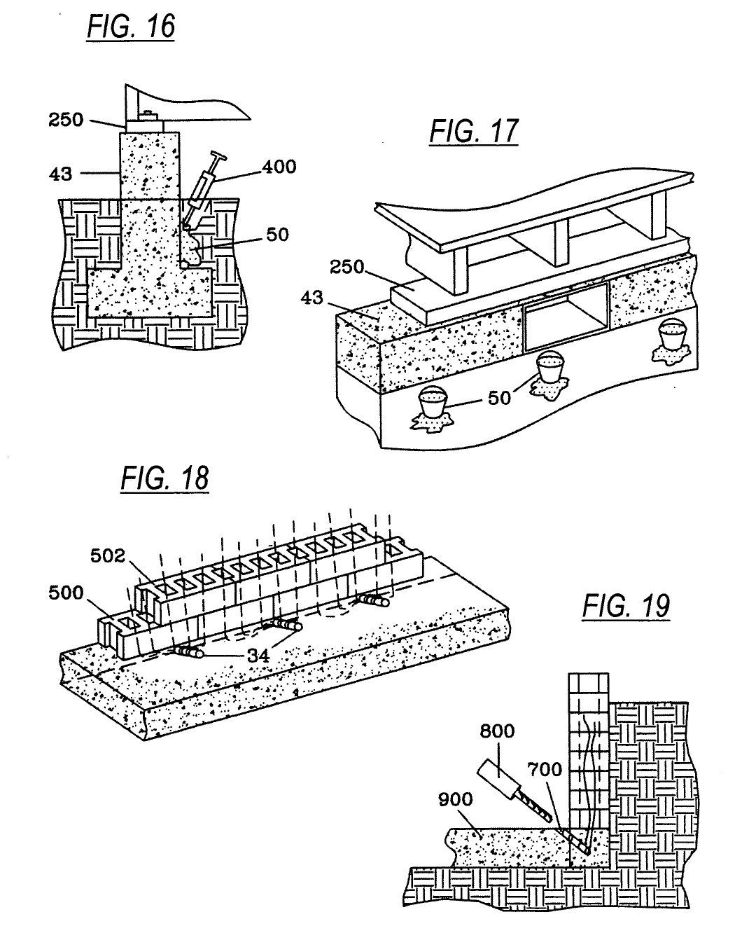

In another embodiment as shown in FIGS. 16 and 17, the controlled release device comprising the polymer matrix and insecticide can be applied via a hot melt. This embodiment is designed to meet the needs of structures already in place. As stated above, the polymer matrix can comprise any of the four above-named polymer groups. Similarly, any of the above-named insecticides can be utilized. However, it is preferable to use high or low density polyethylene with either a pyrethrin. Although tailored to the user, the concentrations of the various substances in the hot-melt application should range from about 70 to about 95 for the polymer, from about 5 to about 30 for the insecticide and from about 0 to about 30 for filler/carrier for optimal results.

FIG. 16 shows hot melt 50 being injected by a syringe 400 into the ground near a concrete foundation 43. The concrete structure 43 supports a wooden structure 250. FIG. 17 shows the spacing between the hot melt 50 which has already been injected into the ground.

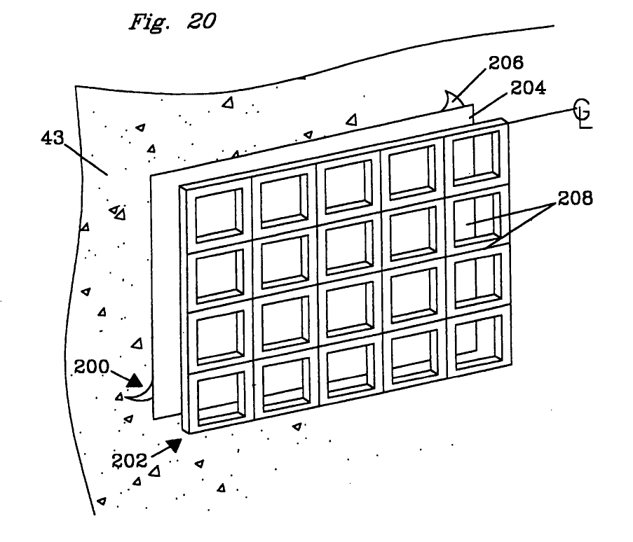

In another embodiment, FIGS. 18 and 19 illustrate the use of insecticide to fumigate a structure 500. By injecting or placing the controlled release device in or near a structure which can be fumigated, the insecticide released from the controlled release device can vaporize, thereby fumigating the structure. FIG. 18 illustrates the use of plugs 34 to fumigate a structure 500 made of building blocks 502. Similarly, FIG. 19 illustrates a mode of applying the controlled release device by using a drill 800 to bore a hole 700 into a cement slab 900. Once inserted, the plug is able to fumigate the structure.

Another embodiment of the device of the present invention is shown in FIG. 20. A first polymer 200 of medium or high density polymer having a low vapor pressure insecticide is combined with a second polymer 202 of low density having a more volatile, vis higher vapor pressure insecticide. High, medium and low density are terms well known in the polymer art referring to the degree of cross linking within a polymer. High vapor pressure is defined as vapor pressure in excess of about 1 millipascal and preferably ranges from about 10 millipascals to about 100 millipascals. Low vapor pressure is defined as less than 1 millipascal and preferably ranges from about 0.05 millipascals to about 0.5 millipascals. The first polymer 200 preferably has a thickness in the range from about 1/32 to ⅛ inches. The low vapor pressure insecticide is preferably permethrin or lambda cyhalothrin. The preferred material of the first polymer 200 is selected from among polyurethane, high density polyethylene and polypropylene. The second polymer 202 is placed adjacent to and preferably attached to the first polymer 200. It is preferred that the first polymer 200 be water and radon impermeable. Hence, the first polymer 200 is preferably a sheet that may be a film or spun bonded. According to the present invention, the first polymer 200 may be in two sub-parts with one sub-part 204 a permeable medium or high density polymer containing the low vapor pressure insecticide and another sub-part 206 an impermeable layer having no insecticide within. The impermeable layer has an advantage for handling of preventing or reducing exposure/contact of the installer with the bioactive chemical. The impermeable layer may be, for example, Mylar, saran or Saranax.

The second polymer 202 is a low density polymer, preferably an ethylene vinyl acetate, a low density polyethylene or blend thereof. The more volatile or higher vapor pressure insecticide placed within the second polymer is preferably a synthetic pyrethroid, for example tefluthrin.

The second polymer 202 may be in the form of pellets as previously described and the first and second polymers deployed with the first polymer under a sill plate on a foundation and the second polymer scattered in the soil adjacent the foundation. More preferably, the second polymer 202 is in the form of an open mesh, either woven or non-woven as shown. Mesh openings may range from touching but not sealed to about 1 to four inches square and ribs 208 having a cross section width of from about 1 mil to about ⅛ inch. A scrim that can be made from polyethylene, polypropylene, or polyester may be used as the mesh. With a first polymer 200 sheet and a second polymer 202 open mesh, the device of the combination of the first and second polymers 200, 202 is preferably placed below grade. The first polymer sheet 200 is placed adjacent the second polymer 202 open mesh with the first polymer 200 sheet in contact or near a foundation 43 and between the foundation and the second polymer 202 open mesh. The mesh material may absorb bioactive chemical and contribute to the reservoir of bioactive material.

In operation, the first polymer 200 maintains a physical/chemical barrier against insect intrusion. However, because of the slow release of the first polymer 200, very little insecticide is released that would be available to create an exclusion zone within about the first year after installation. In addition, it is impossible to install a defect free barrier because of penetrations, for example electrical and plumbing, and because of punctures or tears during construction. Accordingly, the second polymer 202 is deployed to create exclusion zones within a few days of installation thereby preventing insect access through the imperfections of the first polymer 200. The first polymer 200, therefore, has three functions: insect barrier, vapor/moisture barrier, and radon barrier. The first polymer 200 is designed to last at least 10 years and preferably up to and in excess of 20 years. The second polymer 202 is designed to last at least 5 years and preferably up to about 10 years. By the time that the second polymer 202 is depleted and no longer effective against insects, the first polymer 200 will have developed a concentration of released insecticide sufficient to maintain the exclusion zone.

The Preferred Multi-Layer Barrier

Yet another embodiment of the present invention is a multi-layer barrier which includes at least three layers: a pesticide-releasing layer and two pesticide-retaining layers. The pesticide-retaining layers are on either side of a pesticide-releasing layer. The pesticide-releasing layer (i.e., the “active” or pesticidal active-ingredient containing layer) contains at least one pesticide. The pesticide-releasing layer releases the at least one pesticide. The pesticide-retaining layers allow only a minute amount of the pesticide to be released out of the barrier. The inner, active layer is sandwiched between the two pesticide-retaining layers so that substantially no pesticide is released from the barrier. The thickness of the barrier is generally in the range of from about 0.010 inch (10 mil) to about 0.030 inch (30 mil) and preferably about 0.014 (14 mil) to about 0.016 inch (16 mil). The multi-layer barrier can be formed into a sheet or film and placed to surround areas such as foundations for houses which need to be protected from crawling insects such as termites and other pests.

This multi-layer barrier protects areas and/or structures by preventing pests such as crawling wood-boring insects and termites from entering into protected areas and/or structures and by repelling and/or preventing pests from crossing the barrier. The multi-layer barrier protects areas and/or structures for a prolonged period of time while avoiding harmful effects on installers of the barrier, persons who visit or occupy the protected areas and/or structures and on the environment. The release of pesticide from the barrier is minimal so that the barrier can be handled by installers without adverse consequences. The minimal release of pesticide provides minimum impact on the environment and allows the barrier to last for a prolonged period of time, generally up to 10 or even 30 years. The multi-layer barrier can be installed beneath the foundation of buildings prior to construction so as to offer new-construction property owners long-term protection against pests such as crawling wood-boring insects and termites. In addition to keeping pests out of protected areas and/or structures, the multi-layer barrier assists in preventing moisture and harmful gases such as radon from penetrating the protected area and/or structure.

The barrier of this embodiment of the invention may include one or more additional layer or layers. The additional layer or layers can be placed in any desirable location with respect to the pesticide-releasing layer and the pesticide-retaining layers but an additional layer is preferably placed between the pesticide-releasing layer and the pesticide-retaining layer.

The barrier of this embodiment of the invention can include an additional layer or layers which add strength and puncture resistance to the barrier. This additional layer or layers can be placed in any desirable location with respect to the required layers but an additional layer is preferably placed between the pesticide-releasing layer and the pesticide-retaining layer. The multi-layer barrier may be in the form of a thin sheet or film which includes at least one layer which provides strength and puncture resistance to the sheet or film. The thickness of the strength and puncture resistance layer generally ranges from about 0.002 inch (2 mil) to about 0.006 inch (6 mil), preferably about 0.004 inch (4 mil).

The barrier of this embodiment of the invention can also include one or more additional protective layers to protect the barrier from environmental factors such as ultraviolet rays. The additional protective layer(s) protect the barrier from UV rays during installation and when the barrier is exposed to sunlight thereafter. The additional protective layer(s) can be placed in any location with respect to the other layers but are generally placed outside the other layers of the barrier. The protective layer(s) can be made of heat sealable polymers to facilitate heat sealability of the barrier. The thickness of the protective layers generally ranges from about 0.0005 inch (0.5 mil) to about 0.003 inch (3 mil), preferably about 0.001 inch (1 mil). The protective layers generally range from about 15% by weight to about 30% by weight of the barrier, preferably about 22% by weight of the barrier. The area densities of the protective layers generally range from about 13 grams of material per square meter to about 78 grams of material per square meter, preferably about 26 grams of material per square meter.

The layers of the barrier are held together or bonded to each other to form a unitary multi-layer product. The layers can be bonded to each other either directly or by the use of bonding layers. For example, a strength and puncture resistance layer can be bonded to the active layer (i.e., the pesticide-releasing layer) and to the pesticide-retaining layer(s) using a bonding layer. Similarly, the strength and puncture resistance layer can be bonded to the pesticide-releasing layer using a bonding layer. One advantage of using one or more bonding layers to secure the layers of the barrier to each other is that the active layer can be made from a polymer which need not be bondable to the pesticide-retaining layer or additional layers. This allows for the use of polymers in the active layer (i.e., the pesticide-releasing layer) that have low melting points. The lower processing temperatures reduce losses of pesticide in the process of making the active layer.

The pesticide-retaining layers are preferably made of a polymeric material which allows only minute amounts of the pesticide to pass through such that substantially no pesticide is released from the barrier. The preferred polymer is Saranex® available from The Dow Chemical Company of Midland, Mich. The thickness of each of the pesticide-retaining layers generally ranges from about 0.001 inch (1 mil) to about 0.005 inch (5 mil), preferably about 0.002 inch (2 mil). The pesticide-retaining layers generally range from about 20% by weight to about 40% by weight of the barrier, preferably from about 25% to about 35% by weight of the barrier, more preferably about 30% by weight of the barrier. The area densities of the pesticide-retaining layers generally range from about 26 grams of material per square meter to about 130 grams of material per square meter, preferably about 60 grams of material per square meter. In this embodiment of the present invention, the pesticide-retaining layer(s) rather than the pesticide-releasing layer control the release of the pesticide from the barrier. However, the pesticide-releasing layer can assist in assuring that only minute amounts of the pesticide are released by controlling the release of the pesticide from the pesticide-releasing layer. The release rate from the barrier can, in some cases, be below detectable limits.

The pesticide-releasing layer can be made of a polymeric matrix and a pesticide which is dispersed throughout the polymeric matrix. The polymeric matrix may be a controlled-release polymeric matrix which is formed into a film. In one embodiment of the present invention, the polymeric matrix is made from low density polyethylene. Linear low density polyethylene is currently preferred as the polymeric matrix material because it has a lower melting point than other polyethylenes. The low density polyethylene may be a metallocene-catalyzed low density polyethylene. Other suitable polymers for use in the polymeric matrix include, but are not limited to, urethane, polyurethane, epoxy, silicone, polyethylene+wax (PE+wax), aromatic polyesters, pellethane, ethylvinyl acetate (EVA), polyethylene, high density polyethylene, low density polyethylene, vinyl acetate, polyester, santoprene, neoprene, polyisoprene, polypropylene, copolymers or blends of polyethylene and polypropylene, polybutylene, epoxy polymers, polyamides, acrylate-styrene-acrylonitrile, unsaturated polyesters, silicones, and combinations thereof. The polymer for use in the polymeric matrix may be hydrophobic.

Examples of suitable pesticides for use in the pesticide-releasing layer include, but are not limited to, pyrethroids, neonicotinoids, isofenphos, fenvalerate, pyrethrins, and combinations of these types of compounds. The preferred pesticides for use in the pesticide-releasing layer include tefluthrin, permethrin, lambda cyhalothrin, resmethrin, deltamethrin, cypermethrin, cyphenothrin, cyfluthrin, deltamethrin, chlorpyrifos, fenoxycarb, diazinon, dichlorophen, methyl isothiocyanate, pentachlorophenol, tralomethrin, chlorfenapyr, fipronil, neonicotinoids and combinations of these compounds. Examples of suitable neonicotinoids include, but are not limited to, thiamethoxam, nitenpyram, imidacloprid, clothianidin, acetamiprid, and thiacloprid. One preferred pesticide for use in the pesticide-releasing layer is lambda cyhalothrin. Lambda cyhalothrin is a highly potent termiticide with a lethal concentration that kills 99 percent of test termites (LC₉₉) of 0.0001 μg/termite for the most important United States termite species, Reticulitermes flavipes. In some embodiments, at least one of the pesticides in the pesticide-releasing layer is present in an amount of at least 5% of the pesticide-releasing layer by weight. In other embodiments, at least one of the pesticides in the pesticide-releasing layer is present in an amount of at least 10% of the pesticide-releasing layer by weight.

The multi-layer barrier provides several modes of action against termites. The multi-layer barrier provides lethal insecticidal protection by using pesticide such as lambda cyhalothrin in the barrier to deliver a lethal dose of pesticide which may be transferred to termites following transient contact with the barrier. The multi-layer barrier also provides repellant protection against termites. The multi-layer barrier further provides physical protection against termites because the barrier preferably has external pesticide-retaining layers which are smooth and tough so that termites cannot initiate feeding on the barrier.

The pesticide-releasing layer which is made of a polymeric matrix and a pesticide dispersed through the matrix may also include a carrier such as carbon black (including lamp black and gas black). Carbon black in the form of lamp black has been found to provide an advantage of not deactivating or decomposing the pesticide, being easier to extrude and easier to keep from agglomerating. The use of carbon black in the form of lamp black assists in producing a friable mixture of substantially dry or non-sticky flowable particles and in preventing evaporation of the pesticide during extrusion. The thickness of the pesticide-releasing layer is generally in the range from about 0.001 inch (1 mil) to about 0.020 inch (20 mil), preferably from about 0.001 inch (1 mil) to about 0.005 inch (5 mil), more preferably about 0.002 inch (2 mil) or 0.0037 inch (3.7 inch). The pesticide-releasing layer generally ranges from about 15% by weight to about 30% by weight of the barrier, preferably from about 22% by weight to about 25% by weight of the barrier, more preferably about 24% by weight of the barrier. The area density of the pesticide-releasing layer generally ranges from about 22 grams of material per square meter to about 115 grams of material per square meter, preferably about 45 grams of material per square meter.

The pesticide-releasing layer preferably releases the pesticide in a controlled manner. This controlled release assists the pesticide-retaining layer in releasing only minute amounts of the pesticide from the barrier to help in achieving a substantially non-releasing barrier. In other words, the release of only minute amounts of the pesticide from the barrier can be assisted by controlling the release from the active layer (i.e., the pesticide-releasing layer).

In addition to pesticides which repel and prevent penetration by insects, it may be desirable to include one or more fungicides in the barrier. The fungicide(s) can be included in the pesticide-releasing layer containing an insecticide or in a separate fungicide-releasing layer. The separate fungicide-releasing layer may be located inside the pesticide-retaining layers. One or more fungicides can be included to prevent deterioration of the integrity of the barrier by fungi.

The term “fungicide” as utilized herein is intended to cover compounds active against phytopathogenic fungi that may belong to a very wide range of compound classes. Examples of compound classes to which the suitable fungicidally active compound may belong include both room temperature (25° C.) solid and room temperature liquid fungicides including, but not limited to, triazole derivatives, strobilurins, carbamates (including thio and dithiocarbamates), benzimidazoles (such as thiabendazoles), N-trihalomethylthio compounds (such as captan), substituted benzenes, carboxamides, phenylamides, phenylpyrroles, and mixtures thereof. Suitable fungicides also include trichloronitromethane, a mixture of methylisothiocyanate and 1,3-dichloropropane, sodium N-methyl dithiocarbonate, 2,3,5,6-tetra-chloro-1,9-benzoquinone, calcium cyanamide, biphenyl, copper naphthenate, dichlorophen, fentin hydroxide, and combinations of these compounds.

The fungicidally active compound(s) are employed in a fungicidally effective amount in the active layer of the multi-layer barrier. Mixtures of one or more of the foregoing fungicidally active compounds also are usable as an active component in the practice of the present invention.

Where the barrier of this embodiment of the invention includes one or more strength and puncture resistance layers, the strength and puncture resistance layer(s) are preferably made out of scrim. The strength and puncture resistance layer(s) assist in preventing tears and punctures and in providing tensile strength to the barrier. The preferred scrim is made out of a woven polymer. Especially preferred are woven polymers made of high density polyethylene. The thickness of the scrim is generally in the range from about 0.002 inch (2 mil) to about 0.006 inch (6 mil), preferably about 0.004 inch (4 mil). The scrim layer generally ranges from about 11% by weight to about 24% by weight of the barrier, preferably from about 17% by weight to about 18% by weight of the barrier. The area density of the scrim layer generally ranges from about 30 grams of material per square meter to about 95 grams of material per square meter, preferably about 62 grams of material per square meter.

To reduce the release of pesticide from the pesticide-releasing layer at the edges of the barrier, the pesticide-retaining layers can be made wider and longer than the corresponding pesticide-releasing layer(s) and the pesticide-retaining layers advantageously can be bonded to each other either directly or by a bonding layer.

Placing one or more additional layers (i.e., the layers other than the pesticide-releasing layer) inside the pesticide-retaining layers offers an advantage if the barrier becomes penetrated by a pest. As pesticide is released, the additional layer(s) become impregnated with the pesticide. Accordingly, the additional layer(s) offer additional physical and pesticidal protection against the pests going through the barrier.

One advantage of the multi-layer barrier according to this embodiment of the present invention is that the barrier can prevent termites, wood boring ants, and other pests from entering a structure built in whole or in part of wood. Another advantage is that the barrier can prevent pests from crossing it for a prolonged time, as long as 10 or even 30 years. Yet another advantage is that the outside surfaces of the barrier are substantially free of pesticide when the barrier is installed. This leads to increased safety for handlers and installers of the barrier. A still further advantage of this embodiment of the invention is that the process manufacture of the barrier is efficient, and the barrier can be produced in large quantities using conventional commercially available equipment. In addition to keeping the pest out of a protected area and/or structure, the barrier according to this embodiment of the present invention prevents moisture and harmful gases from penetrating the protected area and/or structure.

In accordance with one aspect of the invention, the barrier comprises a plurality of polymeric layers which are bonded together to form a thin flexible film. The film can be placed to surround areas such as foundations for houses which need to be protected from crawling insects such as termites and other pests.

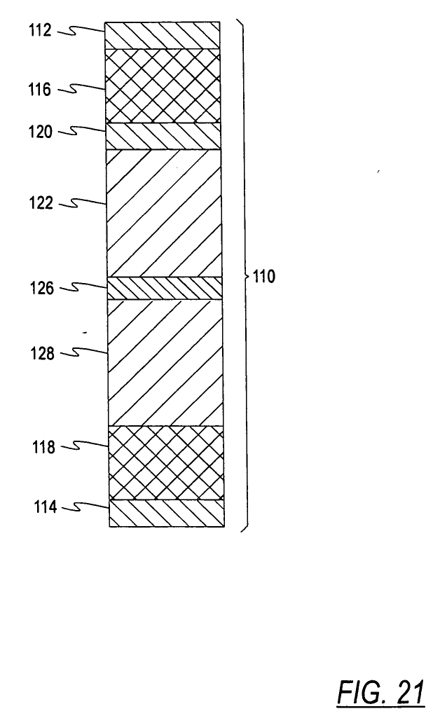

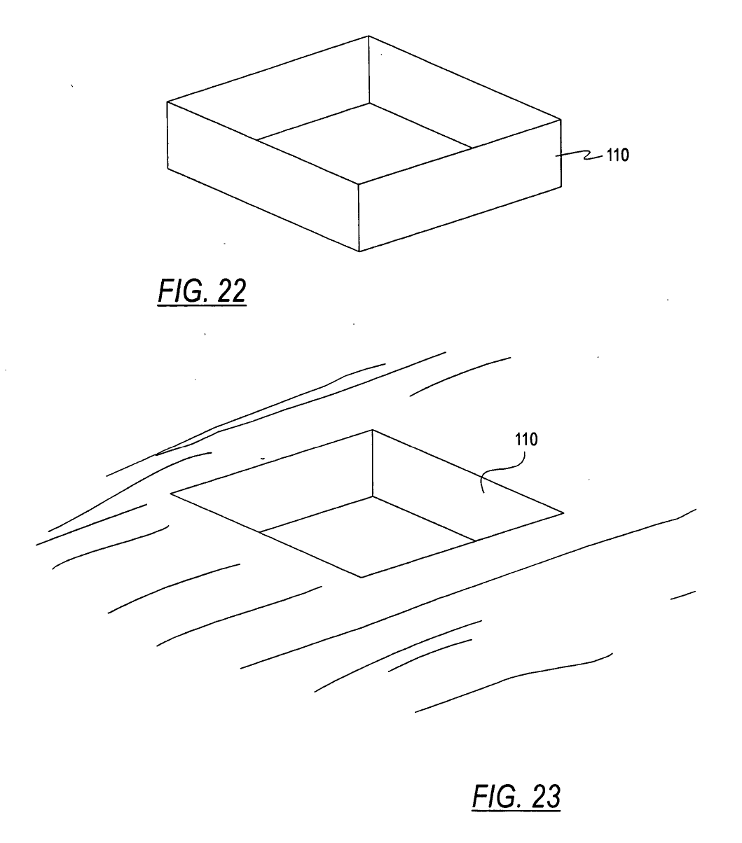

The currently preferred multi-layer barrier of the present invention is composed of a thin eight-layer polymeric film. The layers are bonded together to form a flexible film. The thickness of the currently preferred barrier film ranges from about 0.015 inch (15 mil) to about 0.016 inch (16 mil). The width of the currently preferred barrier film ranges from about 81 inch to about 83 inch. The weight of the currently preferred barrier film is approximately 327 grams per square meter. The eight layers of the currently preferred film are schematically shown in cross-section in FIG. 21.

Referring now to FIG. 21, a barrier film 110 includes outside layers 112 and 114. The outside layers 112, 114 are made of blends of an extrusion-coating grade polyolefin plastomer (sold under the brand name and model number of Affinity® PT1450 by The Dow Chemical Company), a color concentrate (a blend produced by Colortech Inc. of Brampton, Ontario, Canada of the carbon black Vulcan® 9 manufactured by the Cabot Corporation and LDPE), and extrusion-coating grade polyethylene (Novapol® LC-0522-A available from Nova Chemicals Canada Ltd.). The materials used to make the outside layers 112, 144 are also referred to below as the “New Generation Resin” or “NGR”. The materials used to make the outside layers 112, 114 assist in providing ultraviolet protection and heat sealability to the barrier. The melting point of the outside layers 112, 114 is approximately 110° C. The life expectancy of the outside layers 112, 114 is expected to be comparable to moisture barriers currently being used during construction, and the material is expected to last indefinitely when applied underground. The outside layers 112, 114 have a thickness of approximately 0.0011 inch (1.1 mil) and have approximately 26 grams of material per square meter in the preferred embodiment.

Inside the outside layers 112, 114 are the pesticide-retaining layers 116, 118. The pesticide-retaining layers 116, 118 are made of Saranex® 14, a product of The Dow Chemical Company. Saranex® 14 has a melting point above 143° C. and is not believed to be biodegradable or photodegradable. Saranex® 14 is a five-layer coextruded product which consists of low density polyethylene, vinylidene chloride/vinyl chloride copolymer (i.e., Saran), ethylene/vinyl acetate copolymer, and silicon dioxide. The layers made of Saranex® 14 (i.e., layers 116 and 118) have a thickness of approximately 0.002 inch (2 mil) and have area densities of approximately 53 grams of material per square meter in the preferred embodiment.

To the inside of pesticide-retaining layer 116, there is a bonding layer 120 which bonds the pesticide-retaining layer 116 to a scrim layer 122. The bonding layer 120 is made of the same material as the pesticide-retaining layers 112, 114. The bonding layer 120 has a thickness of approximately 0.0011 inch (1.1 mil) and an area density of approximately 26 grams of LDPE per square meter in the preferred embodiment.

The scrim layer 122 is made of high density polyethylene, specifically Sclair® HDPE No. 99G available from Nova Chemicals Corporation. The scrim layer is preferably a woven HDPE. The HDPE used to make the scrim layer 122 is extruded into a sheet and slit into tapes. The tapes are then pre-stressed and woven into a sheet, which is incorporated into the barrier film 110 to provide tensile strength and resistance to puncture. The HDPE used to make the scrim layer 122 is very similar to the resin used to make common water piping and is expected to have a comparable lifetime. The scrim layer 122 has a thickness of approximately 0.004 inch (4 mils) and an area density of approximately 63 grams of material per square meter in the preferred embodiment.

A bonding layer 126 bonds the scrim layer 122 to an active layer 128. The bonding layer 126 is an extrusion-coating grade low density polyethylene available from Nova Chemicals Canada Ltd. such as Novapol® LC-0522-A. The bonding layer 126 has a melting point of approximately 165° C. The bonding layer 126 has a thickness of approximately 0.001 inch (1 mil) and an area density of approximately 25 grams of material per square meter in the preferred embodiment.

Between the bonding layer 126 and pesticide-retaining layer 118 is the active layer 128. In some embodiments of the invention, the active layer 128 is made from about 0.82% by weight to about 1% by weight lambda cyhalothrin technical (85% w/w), from about 0.85% by weight to about 1.05% by weight carbon black, Lamp black #6 (which is also known as Lamp black Superfine #6) available from General Carbon Company, and from about 20.9% by weight to about 23.1% by weight low density (LDPE) polyethylene resin. In another embodiment, the active layer 128 is made from 11.74 weight percent lambda cyhalothrin in a 85.2 weight percent technical solution, 10.87 weight percent Lamp black #6, and 77.39 weight percent low density polyethylene (LDPE) resin. The LDPE resin is preferably PE XU59400.00 (which is also known as PE XU59400) available from The Dow Chemical Company, a metallocene-catalyzed extrusion coating grade LDPE. This particular LDPE was chosen for its low melting point of approximately 80° C. and its extrusion coating ability. The active layer 128 is about 23% by weight of the barrier film 110, has a thickness of approximately 0.002 inch (2 mil), and an area density of approximately 45 grams of material per square meter in the preferred embodiment.

In the eight-layered barrier film described above, the outside layers 112 and 114 and the bonding layer 120 together comprise approximately 22.2% by weight of the barrier film 110. The pesticide-retaining layers 116, 118 together comprise approximately 29.7% by weight of the barrier film 110. The scrim layer 122 comprises approximately 17.8% by weight of the barrier film 110. The bonding layer 126 comprises approximately 6.4% by weight of the barrier film 110. The active layer 128 is about 23.9% by weight of the barrier film 110.

The release rate of bioactive chemicals from the bonding layer 126 to the other layers is greater than the release rate of bioactive chemicals from the barrier film 110 to the exterior of the barrier film 110. The release rates of lambda cyhalothrin in the preferred eight-layer embodiment were measured to be less than 0.002 μg per square centimeter of film per day. The barrier film 110 serves to prevent the entrance of wood deteriorating organisms into a structure while resulting in a negligible concentration of lambda cyhalothrin in the soil and other surroundings.

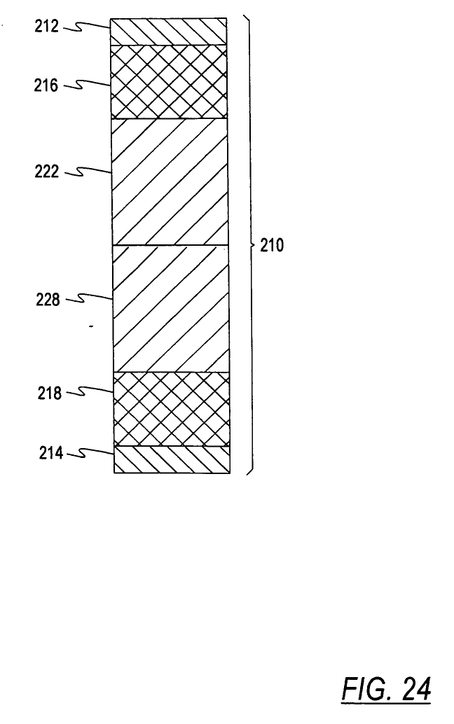

Another suitable multi-layer barrier may be composed of a thin six-layer polymeric film where the layers are bonded together to form a flexible film. In one embodiment, the thickness of the six-layer polymeric film is about 0.012 inch (12 mil), the width ranges from about 81 inch to about 83 inch, and the weight is about 263 grams per square meter. The layers of one suitable six-layered film are schematically shown in cross-section in FIG. 24 and are described below.

Referring now to FIG. 24, a barrier film 210 includes outside layers 212, 214. The barrier film 210 serves to prevent the entrance of wood deteriorating organisms into a structure while resulting in a negligible concentration of lambda cyhalothrin in the soil and other surroundings. In one embodiment, the outside layers 212, 214 are made of blends of an extrusion-coating grade polyolefin plastomer, a color concentrate, and extrusion-coating grade polyethylene as described above with respect to the eight-layer film and referred to as the “New Generation Resin” or “NGR”. The outside layers 212, 214 may have a thickness ranging from approximately 0.0005 inch (0.5 mil) to about 0.003 inch (3 mil) and may have from approximately 13 grams to 78 grams of material per square meter.

Inside the outside layers 212, 214 are the pesticide-retaining layers 216, 218. In one embodiment, the pesticide-retaining layers 216, 218 are made of Saranex® 14 as described above. Layers 216 and 218 may have a thickness ranging from approximately 0.0005 inch (0.5 mil) to about 0.003 inch (3 mil) and have from approximately 26 grams to 130 grams of material per square meter.

To the inside of pesticide-retaining layer 216, there is structural layer 222. In one embodiment, the structural layer 222 is made of HDPE as described above. The structural layer 216 may have a thickness ranging from approximately 0.002 inch (2 mil) to about 0.006 inch (6 mil) and may have from approximately 31 grams to 93 grams of material per square meter.

Between the structural layer 222 and pesticide-retaining layer 218 is the active layer 228. In one embodiment, the active layer 216 is made from 0.91 weight percent lambda cyhalothrin in an 85 weight percent technical solution, 0.95 weight percent Lamp black #6, and 22 weight percent LDPE resin. The active layer 216 may have a thickness ranging from approximately 0.002 inch (2 mil) to about 0.005 inch (5 mil) and may have from approximately 22 grams to 115 grams of material per square meter.

The release rate of lambda cyhalothrin in the six-layer embodiment was measured to be less than 0.002 μg per square centimeter of film per day. The barrier film 210 serves to prevent the entrance of wood deteriorating organisms into a structure while resulting in a negligible concentration of lambda cyhalothrin in the soil and other surroundings.

The present invention also provides efficient methods for making the multi-layer barrier using conventional, commercially available equipment. In accordance with one aspect of the present invention, lamp black or gas black is used in a premix for making the active layer. Lamp black achieves the desired flowability of the premix but unlike a number of other types of carbon black, lamp black does not have detrimental effects on the activity of the pesticide such as deactivating the pesticide.

Method of Making the Barrier Film

The multi-layer barrier film described above may be formed by a variety of methods. In one method, the carrier such as carbon black is mixed with particles of a polymer to form a mixture. One or more pesticides are added in a liquid form to the mixture while maintaining the mixture at a temperature below the temperature at which the pesticide decomposes but above the melting temperature of the pesticide to form a friable premix. The premix is melt extruded to form a thin active layer. The premix is extruded along with the desired additional layer or layers to form a barrier film. The desired number of layers, the type of layers selected, the order of the layers, and the materials used in making the layers depend upon a variety of factors including, but not limited to, the end application of the barrier film, the desired length of protection against pest intrusion, the type of area and/or structure being protected, the specific types of pests, manufacturing costs and capabilities, and the like.

The active layer may be prepared by combining the pesticide or bioactive chemical with the carrier to form a bound friable mix and adding the bound friable mix to the polymeric matrix. The active layer may also be prepared by mixing the polymer and the carrier to form polymer-carrier mixture followed by the addition of the pesticide or bioactive chemical.

The eight-layer barrier film 110 described above may be formed by the following preferred method. To produce the active layer 128, the polyethylene resin and carbon black in form of lamp black are combined and mixed. A suitable mixer is a Marion-type mixer. Where a Marion-type mixer is used, the mixer is sealed and an agitator is activated. The polyethylene resin and carbon black are mixed until they are well blended and carbon agglomerates are reduced in size. The polyethylene resin is preferably in pellet form and cryogenically ground to a 35 mesh powder. The bulk temperature of the mixture is preferably kept below 60° C.

Next, lambda cyhalothrin is gradually added as a molten spray while maintaining the mixing of the polyethylene resin-carbon black mixture. In the preferred embodiment, an 85.2% weight percent solution of technical grade of lambda cyhalothrin is used. The mixing is continued until contents are uniformly blended. The mixture may then be stored, for example in plastic-lined drums.

The mixture is next pelletized by being fed into an extruder/pelletizer fitted with a die. In the preferred embodiment, an extruder/pelletizer fitted with a ⅛ inch strand die is used and the extruder temperature is maintained at approximately 85° C. along the length of the extruder barrel and die. The extruder strand may require water cooling before pelletizing. Pellets are made approximately ⅛ inch long in the preferred embodiment. The pellets are next dried. The pellets are dried in a hot air cyclone drier or, if necessary to achieve more complete drying, placed in flat trays and put into a 60° C. forced-air oven to dry.

The premix pellets are extruded and laminated between two multi-layer films via a lamination process. Specifically, the premix pellets are extruded and laminated between two multi-layer films designed to hold the bioactive premix material within a final barrier film 110. A conventional extruder such as a single screw or double screw exturder may be used to extrude the layer 128.

The two multi-layer films used in the lamination step are pre-fabricated. The first multi-layer film comprises layers 114 and 118 described above (i.e., the pesticide-retaining layer made of Saranex® 14 and the adjacent NGR layer). The second multi-layer film comprises layers 112, 116, 120, 122, 126 114 and 118 described above (i.e., the NGR layer, the adjacent pesticide-retaining layer made of Saranex® 14, the adjacent NGR layer, the adjacent HDPE layer, and the adjacent LDPE layer). The layers of the second multi-layer film are oriented so the first NGR layer (i.e., layer 112) is on the outer surface of the final product.

The premix pellets are diluted with virgin polyethylene resin to a desired concentration of lambda cyhalothrin and fed to an extruder to be directly laminated between the first and second multi-layer films to form the barrier film 110. The lambda cyhalothrin concentration of the barrier film 110 is 0.77 wt. %, or 2.75 grams per square meter of barrier film 110 in the preferred method. The barrier film 110 is then rolled into bolts and packaged for sale or delivery for sizing and seaming.

Moisture in the premix, particularly from the carbon black, can cause problems during manufacture such as bubbling in the active layer 128 as that layer exits an extruder die. This may be solved by drying the premix in an incubator set at approximately 54° C. for a period of approximately 12 hours, which has been found to substantially dry the premix so that bubbling does not occur. Care must also be taken to reduce atmospheric moisture contact with the premix concentrate.

Further, carbon agglomerates can form a highly textured surface in the barrier film 110. Carbon agglomeration is a problem because this results in heterogeneous distribution of the bioactive ingredients (lambda cyhalothrin for example) in the active layer 128. This problem may be reduced by sieving the carbon black component of the scrim layer 122 through a 100 mesh screen prior to use. Proper carbon black dispersion may also be achieved through the use of high energy mixers such as Henschel-type mixers and twin screw extruders, or the use of masterbatching whereby high carbon loading is used to increase polymer melt viscosity, thereby increasing shear stress in an extruder to result in carbon dispersion. A lower extruder temperature or the use of an extruder screw having a high shear mixing section may also effect better carbon distribution. One example of an extruder screw having a shear mixing section is a screw design having a fluted barrier flight built into the screw. When such a screw is used, the polymer melt is forced to flow over the barrier flight, which is close to an extruder barrel. This subjects the polymer melt to a high shear rate and thereby increases carbon distribution through the mixture.

Thermal decomposition and volatilization of lambda cyhalothrin occurs in the manufacturing process at temperatures above approximately 160° C., with a breakpoint between approximately 160° C. and approximately 170° C. where lambda cyhalothrin losses become significant. To have a safety cushion for operating conditions, it is beneficial to have a processing temperature of approximately 150° C.

Preferred Method of Off-Site Pre-Forming the Barrier Film

The currently preferred use of the barrier film is in protecting houses from invasion of termites and other wood boring crawling insects. In order to prevent insects from entering the house through the soil, the barrier film of the present invention should be placed between the soil and foundation of the house that is in contact and in the proximity of the soil.

It is currently preferred to make the barrier film of the present invention commercially in sheets which are smaller than the foundation of a house. Accordingly, it is necessary to combine a number of sheets to line the entire foundation with the barrier film. In order to avoid gaps between adjacent sheets, the sheets can be sealed, bonded or otherwise attached to each other.

In accordance with another aspect of the present invention, the barrier film is pre-shaped or pre-formed off-site to fit in its intended location prior to placing the barrier film in its intended location such as in the excavation for the foundation of a house. It is beneficial to combine the sheets of the barrier material to form a pre-shaped barrier which will envelop the entire foundation of a house off-site and then transport it and install it in the excavation for the foundation. The off-site combination of sheets into the shape of the foundation reduces the chances that the sheets will be torn or improperly sealed together so as to leave gaps.

FIG. 22 shows a pre-shaped barrier made of a multi-layer polymeric film. The pre-shaped barrier may be formed by sealing various segments of the barrier. Preferably, the thermoplastic sheets used for sealing the various segments of the barrier are the outside layers of the multi-layer barrier. However, the segments of the barrier can be formed into desired sheets using any other means including overlaying segments of thermoplastic materials on the adjacent barrier sheets. The segments, for example, may be in the form of patches or strips of thermoplastic material. FIG. 23 shows an excavation for a foundation adapted to receive the pre-shaped barrier of FIG. 22.

In an embodiment of the barrier film having a loading of 2.75 μg of lambda cyhalothrin per mm², each mm² of the barrier film contains enough lambda cyhalothrin to kill at least 24,000 individuals of R. flavipes. Resistance to termites and other wood boring pests is preserved by the barrier film even in the event that holes or tears develop in the barrier film. For example, with holes or tears having a size of 2 mm or less, R. flavipes' contact with the exposed active ingredient as they pass through the hole results in high termite mortality.

Not every embodiment of the present invention provides every named advantage. Moreover, additional advantages of the present invention will become apparent upon studying of this specification.

### EXAMPLES

The following examples are provided by way of explanation and to further illustrate the various aspects of the present invention. As such, these examples are provided for illustrative purposes only and are not viewed as limiting the scope of the invention in any manner.

### Example 1

Experiments were conducted to determine the release rate of chlorpyrifos. Loading rates for the insecticide were either 5 wt. % (weight percent) or 10 wt. % depending on the polymer. Release rates were determined for all devices at 50° C.

The polymers evaluated included low melt polyethylene, polyurethane, two epoxies, silicone rubber, and a low melt polyethylene high in waxes to reduce thermal decomposition of the chlorpyrifos. Studies indicated that excessive thermal decomposition of the chlorpyrifos occurred at temperatures in excess of approximately 240° C.; thus, polymer selection was restricted to formulations not requiring excessive heat processing.

Table 1 provides a summary of the results from these studies. Overall, polymer compatibility with chlorpyrifos did not appear to present a problem with the loading rates employed. There was some loss of physical integrity of the polyurethane polymer employed, however, the other polymer systems exhibited no visible degradation at 50° C. Release rates ranged from 10 μg/cm²/day for the silicone rubber to 0.3 μg/cm²/day for Epoxy B.

Using the data provided in Table 1, an estimated product longevity can be approximated. Assuming a device wt. of 0.5 g, with 10% load, then 50 mg of chlorpyrifos is available for release. Thus, for a polymer system having an area of 4 cm², and a release rate of 1 μg/cm²/da, there is sufficient insecticide to last 30 years at elevated temperature. These calculations indicate that a variety of insecticidal products are possible.

TABLE 1
Polymer Formulations and Release Rates for
Candidate Systems Employing Chlorpyrifos

| | Chlorpyrifos | Release Rate |
|---|---|---|
| Polymer Class | Content (%) | (μg/cm²/da)^{a} |
| Polyurethane | 5 | 2.1 ± 1.4^{b} |
| Epoxy A | 5 | <0.1 |
| Silicone | 5 | 10.3 ± 3.5 |
| Urethane | 10 | 1.0 ± 0.3 |
| Epoxy B | 10 | 0.3 ± 0.1 |
| PE + Wax | 10 | 1.9 ± 0.3 |

^{a}Release rates performed at 50° C.
^{b}Material exhibited excessive cracking at elevated temperature

### Example 2

Studies were also conducted with similar polymer systems as in Example 1 but with 80% pure pyrethrin. The release rates at 40° C. are provided in Table 2.

TABLE 2
Polymer Formulations and Release Rates for
Candidate Systems Employing Pyrethrin I

| | Pyrethrin I | Release Rate |
|---|---|---|
| Polymer Class | Content (%) | (μg/cm²/day)^{a} |
| Epoxy A | 10 | 0.5 ± 0.2 |
| Silicone | 10 | 21.2 ± 5.4 |
| Urethane | 10 | 15.7 ± 7.1 |
| Epoxy B | 10 | 0.2 ± 0.1 |

^{a}Release rates performed at 40° C.

The release rates were highest for urethane and silicone and lowest for the epoxies. Substantial variability in release rates were encountered and appropriate binders will need to be evaluated.

From the data in Table 2, simple calculations can be performed to determine the possible life of the insecticide systems. As stated in Example 1, there are many variables which can alter the lifetime of an exclusion zone.

### Example 3

Controlled release devices were made and tested to obtain their release rates. All thermoplastic polymers were formulated with 10 percent pesticide, 3 or 7 percent carbon black to absorb liquid pesticide, and 83 to 87 percent by weight of polymer and injection molded into thin sheets about ⅛ inch thick. Specifically, devices made from thermoplastic polymers and deltamethrin and lambda cyhalothrin contained 3 percent of carbon black. The devices made from the remaining pesticides and thermoplastic polymers contained 7 percent of carbon black.

The devices made from S-113 urethane (a thermoset polymer) were made from a polymer mix containing 60% S-113, 40% castor oil and 5% of TIPA catalyst by weight. The polymer mix comprised 90% of the total weight of the device. The pesticide, deltamethrin, comprised the remaining 10% of the device. No carbon black was used in this device. The polymer/pesticide mixture was cast into a ⅛ inch thick sheet and heated at about 60° C. for about 40 to 60 minutes to cure the cast sheet.

One inch squares were then cut from the thin sheets that were injection molded or cast and the squares were tested for release rates. The following release rates were obtained:

TABLE 3

| Pesticide | Polymer | Release Rate | |
|---|---|---|---|
| Deltamethrin | S-113 urethane | 25.2 | μg/cm²/day |
| | Aromatic 80A | 16.8 | μg/cm²/day |
| | Pellethane 2102-80A | 8.8 | μg/cm²/day |
| | Pellethane 2102-55D | 8.0 | μg/cm²/day |
| | Alipmtic PS-49-100 | 7.2 | μg/cm²/day |
| Cypermethrin | Polyurethane 3100 | 0.4 | μg/cm²/day |
| | Polyurethane 2200 | 0.7 | μg/cm²/day |
| | EVA 763 | 27.3 | μg/cm²/day |
| | Polyethylene MA 778-000 | 4.6 | μg/cm²/day |
| Lambda cyhalothrin | Polyurethane 3100 | 0.4 | μg/cm²/day |
| | Polyurethane 2200 | 0.7 | μg/cm²/day |
| | EVA 763 | 27.3 | μg/cm²/day |
| | Polyethylene MA 778-000 | 4.6 | μg/cm²/day |
| Tefluthrin | Polyurethane 3100 | 6.4 | μg/cm²/day |
| | Polyurethane 2200 | 25.0 | μg/cm²/day |
| | EVA 763 | 40.4 | μg/cm²/day |
| | Polyethylene MA 778-000 | 27.0 | μg/cm²/day |
| Permethrin | Polyurethane 3100 | 1.4 | μg/cm²/day |
| | Polyurethane 2200 | 1.3 | μg/cm²/day |
| | EVA 763 | 28.5 | μg/cm²/day |
| | Polyethylene MA 778-000 | 4.0 | μg/cm²/day |

### Example 4

An experiment was conducted to determine the effect of lambda cyhalothrin (pyrethroid) concentration and insecticide/polymer combination on release rate of insecticide from the polymer. The data are summarized in Table 4.

TABLE 4
Release Rate for Polymer/Pyrethroid Concentration Combinations

| | Pyrethroid | |
|---|---|---|
| | Concentration | Pyrethroid Release |
| Polymer | (wt. %) | Rate (mg/cm²/da) |
| Ethylvinyl Acetate (EVA) | 1 | 0.3 |
| | 5 | 2.2 |
| | 10 | 2.5 |
| Polyurethane | 1 | 0.9 |
| | 5 | 4.4 |
| | 10 | 8.3 |
| Polyurethane/EVA (50/50) | 1 | 2.6 |
| | 5 | 7.2 |
| | 10 | 9.1 |

### Example 5

An experiment was conducted to determine the effectiveness of the exclusion zone against termites. Two species of termites were selected for the tests: Eastern subterranean termite because it is the most common and Formosan subterranean termite because it is the most aggressive.

Test cells were assembled with glass containers. Wood shavings were placed in the bottom of the containers. Insecticide impregnated polymer was placed over the wood chips in a manner that no path or opening existed from above the impregnated polymer to the wood chips. A nutrient free auger was placed above the impregnated polymer. The surface of the auger was the zero datum and the impregnated polymer was mounted at a distance of 5 cm below the surface of the auger. Termites were placed on the surface of the auger and their progress through the auger toward the impregnated polymer noted each day.

The impregnated polymer combinations are shown in Table 5.

TABLE 5
Release Rate for 10 wt. % Pyrethroid

| | | Release Rate |
|---|---|---|
| Polymer | Pyrethroid | (mg/cm²/da) |
| Ethylvinyl acetate | Permethrin | 3.9 |
| Ethylvinyl acetate | Tefluthrin | 4.3 |
| Ethylvinyl acetate | Tefluthrin (2 wt. % fatty acid) | 3.2 |
| Polyethylene | Permethrin | 1.4 |
| Polyethylene | Tefluthrin | 2.2 |
| Polyethylene | Tefluthrin (2 wt. % fatty acid) | 2.0 |

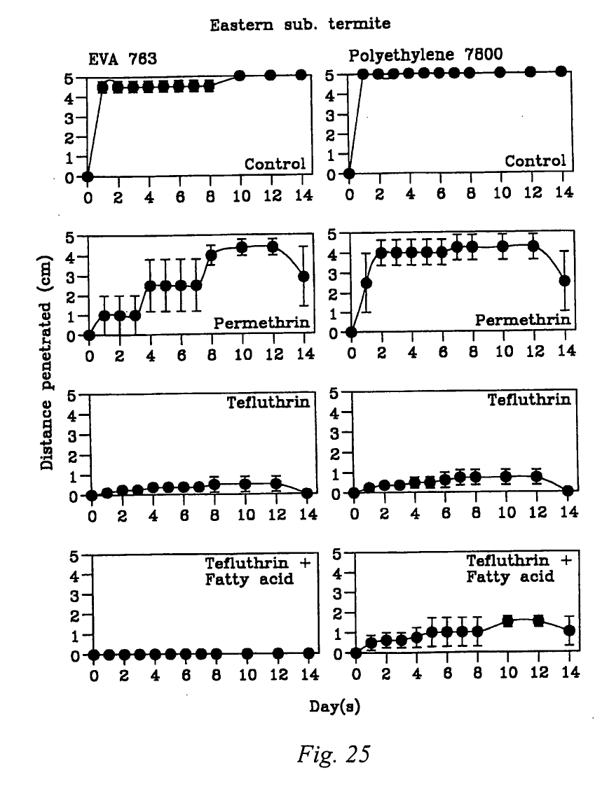

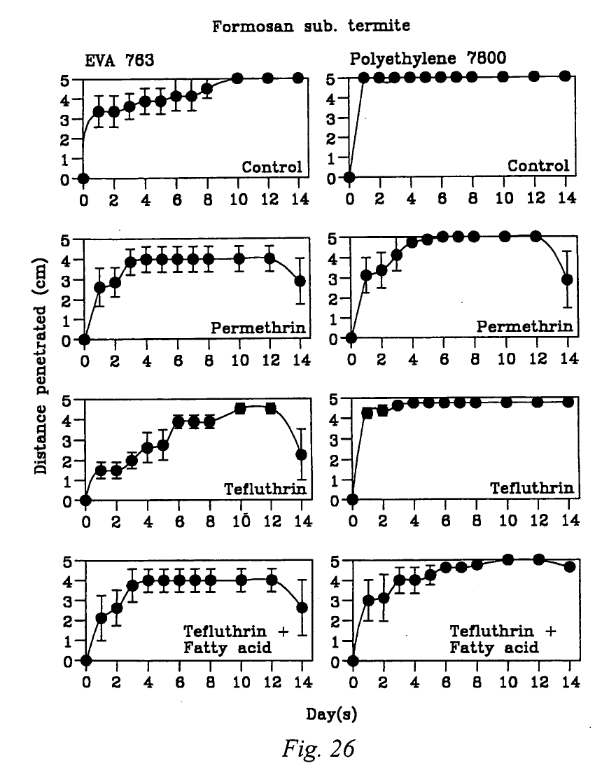

Controls having no pyrethroid in a polymer barrier were also used. The results are shown in FIG. 25 and FIG. 26. In all controls, the termites ate through the polymer and obtained access to the wood chips. The rate of access through ethylvinyl acetate was slower than for polyethylene. For all impregnated polymers, there was no penetration. Because the Formosan subterranean termites are so aggressive, they came closer to the impregnated polymer than the less aggressive Eastern subterranean termites. In fact, the polyethylene with permethrin suffered mandible marks from the Formosan termites, but no holes or penetration. After about 12-14 days, even the Formosan termites were discouraged by the release of insecticide and retreated from impregnated polymer.

### Example 6

An experiment was conducted to demonstrate the effect of a binding carrier on release rate. The active chemicals were tefluthrin and lambda cyhalothrin in an amount of 5 wt. %, the binding carrier was carbon black in amounts of 0 wt. % and 10 wt. %, with the balance high density polyethylene (MA 778-000). Release rates were measured at 6 weeks after fabrication wherein samples were wiped weekly to remove surface accumulation of released active chemical.

The results are shown in Table 6 below.

TABLE 6
Release Rates for 0 wt. % and 10 wt. % Carbon Black

| | Carbon Black | Release Rate |
|---|---|---|
| Active Chemical | (wt. %) | (μg/cm²/day) |
| Tefluthrin | 0 | 3.13 |
| Tefluthrin | 10 | 0.71 |
| Lambda cyhalothrin | 0 | 1.78 |
| Lambda cyhalothrin | 10 | 0.81 |
| Lambda cyhalothrin | 20 | 0.61 |

### Example 7

This example illustrates one method of making a premix which is subsequently used in making an active layer (i.e., the pesticide-releasing layer) of the barrier of the present invention.

Low density polyethylene (PE XU59400 or PE XU59400.00 available from The Dow Chemical Company) is cryogenically ground to form particles having about 35 mesh particle size. The polyethylene particles are then blended with the lamp black carbon (Lamp black Superfine #6 available from General Carbon Company) in a Marion-type paddle until the carbon is dispersed throughout the polyethylene forming a homogeneous mixture having a dry, flowable consistency. Then, with the blender operating with an internal bulk temperature of about 50° C., lambda cyhalothrin available from Syngenta, Inc. is added to the mixture a molten spray. The blender agitation is maintained following the application of lambda cyhalothrin to achieve a homogeneous mixture. The premix contains about 3.2 wt. % of lambda cyhalothrin, about 4 wt. % of lamp black carbon and about 92.8 wt. % of low density polyethylene. The premix can be placed in a forced air oven at about 60-70° C. to reduce its moisture content.

### Example 8

A homogeneous premix having about 10.0 wt. % of lambda cyhalothrin and about 11.3 wt. % of lamp black carbon is prepared using the procedures as described in Example 7.

### Example 9

A premix is prepared using the procedure described in Example 8 except that molten lambda cyhalothrin is applied to the lamp black carbon as a first step, and the mixture is then well blended to form a homogeneously mixed powder. The ground low density polyethylene is then added and further blending takes place until a uniformly dispersed mixture is obtained having a dry, flowable consistency.

### Example 10

A premix is prepared with about 7.9 wt. % of gas black carbon (Colour Black FW200 available from Degussa Corporation) and about 9.5 wt. % of lambda cyhalothrin using the procedure as described in Example 7 except that an Eirich-type mixer utilizing a high-speed agitator was used to blend the components.

### Example 11

Premixes are prepared in accordance with Example 7, Example 8, and Example 10 except that premixes are not dried. The premixes are melt-extruded into a strand and then the strand is cut into pellets.

### Example 12

A premix is prepared having about 7 wt. % of lambda cyhalothrin, about 5 wt. % of a conductive grade carbon black (Vulcan® XC-72R available from Cabot Corporation), and the balance of a low density polyethylene (Novapol® LC-0522-A available from Nova Chemicals Canada Ltd.) using the procedure described in Example 7.

### Example 13

A premix prepared in accordance with Example 12 is injection molded to form thin, circular disks. The molded disks are then chopped into shards using a rotating knife regrinder.

### Example 14

A premix is prepared having about 6 wt. % of lambda cyhalothrin and about 94 wt. % of low density polyethylene in accordance with the procedure of Example 7. The resulting premix had a tacky consistency.

### Example 15

A sheet is prepared having a uniform composition of about 2 wt. % of lambda cyhalothrin (available from Zeneca, Inc.), about 1 wt. % of conductive grade carbon black (Vulcan® XC72R available from Cabot Corporation), and the balance of a high density polyethylene (Microthene® MA77800 available from Quantum Chemical Company).

As a first step, the carbon black is dried in a forced air oven at a temperature of about 105° C. for at least 12 hours or until a constant weight is achieved. The dried carbon black is combined with about an equal amount by weight of powdered high density polyethylene in a Hobart industrial dough mixer and is thoroughly blended. Then, while maintaining agitation, molten lambda cyhalothrin in an amount of about twice the weight of carbon black is slowly incorporated into the mixture. The mixture is then blended with sufficient amount of additional high density polyethylene to reduce the concentration of lambda cyhalothrin in the mixture to about 2 wt. %.

The resulting mixture is then melt-extruded at about 290° C. and cast as a single layer film with a thickness of about 0.03 inch (30 mil).

### Example 16

A sheet is prepared having about 2 wt. % of lambda cyhalothrin, about 1 wt. % of conductive grade carbon black (such as Vulcan® XC72R available from Cabot Corporation), and the balance of a high density polyethylene (Microthene® MA78000 available from Quantum Chemical Company) in accordance with the procedure of Example 15.

### Example 17

A sheet is prepared having about 5% by weight of tefluthrin, about 2.5% by weight of carbon black and the balance of a high density polyethylene (Microthene® MA77800 available from Quantum Chemical Company) using the procedure of Example 15.

### Example 18

A sheet is prepared having about 5% by weight of tefluthrin, about 2.5% by weight of carbon black and the balance of a ethylene vinyl copolymer (EVA 763 available from Quantum Chemical Company) using the procedure of Example 15.

### Example 19

A sheet is prepared having about 10% by weight of tefluthrin, about 5% by weight of carbon black and the balance of a high density polyethylene (Microthene® MA77800 available from Quantum Chemical Company) using the procedure of Example 15.

### Example 20

A sheet is prepared having about 10% by weight of tefluthrin, about 5% by weight of carbon black and the balance of an ethylene vinyl copolymer (EVA 763 available from Quantum Chemical Company) using the procedure of Example 15.

### Example 21

A sheet is prepared having about 10% by weight of permethrin, about 5% by weight of carbon black and the balance of an ethylene vinyl copolymer (EVA 763 available from Quantum Chemical Company) using the procedure of Example 15.

### Example 22

A sheet is prepared having about 10% by weight of permethrin, about 5% by weight of carbon black and the balance of a high density polyethylene (Microthene® MA78000 available from Quantum Chemical Company) using the procedure of Example 15.

### Example 23

A sheet is prepared having about 1% by weight of lambda cyhalothrin, about 0.73% by weight of carbon black (Special Black 6 available from Degussa Corporation), and the balance of a low density polyethylene (Novapol® LC-0522-A available from Nova Chemicals Canada Ltd.) using the procedure of Example 15 except that the melt-extrusion process is conducted at about 130° C. and the cast sheet has a thickness of about 0.002 inch (2 mil).

### Example 24

A sheet is prepared using the procedure of Example 23 except with a lambda cyhalothrin concentration of about 5% by weight and a carbon black concentration of about 3.6% by weight.

### Example 25

A sheet is prepared substantially as described in Example 23 except with a lambda cyhalothrin concentration of about 10% by weight and a carbon black concentration of about 7.3% by weight.

### Example 26

Sheets are prepared in accordance with Example 23, Example 24, and Example 25. The sheets are then laminated on both sides with layers of Saranex® 14 films (available from The Dow Chemical Company) using a thermal press.

### Example 27

A sheet is prepared having about 7.9% by weight of gas black carbon (Colour Black FW200 available from Degussa Corporation), about 9.5% by weight of lambda cyhalothrin, and the balance of a low density polyethylene (PE XU59400 or PE XU59400.00 available from The Dow Chemical Company) using the procedure of Example 15, except that the melt-extrusion process is conducted at about 150° C. and the cast sheet has a thickness of about 0.002 inch (2 mil).

### Example 28

A sheet is prepared comprising two layers of Saranex® 14 bonded together by a melt-extrusion/lamination process. The bonding layer is a comprised of the component mixture as described in Example 26. As a first step, the components of the bonding layer are prepared as a powdered premix. Then, the premix is melt-extruded at about 150° C. directly between two layers of Saranex® 14.

### Example 29

This example describes a method for making an eight-layered sheet. The composition of each of the layers of the sheet is as follows.

Layer Description

1 New Generation Resin (NGR) (available from Fabrene, Inc.) layer composed of black resin (Colortech No. 20413-19 available from Colortech Inc.), extrusion coating grade polyolefin plastomer (Affinity® PT1450 available from The Dow Chemical Company), and low density polyethylene (Novapol® LC-0522-A available from Nova Chemicals Canada Ltd.) having a thickness of about 0.001 inch (1 mil);
2 Saranex® 14 (available from The Dow Chemical Company) layer composed of vinylidine chloride/vinyl chloride copolymer, low density polyethylene, ethylene/vinyl acetate copolymer, and silicon dioxide having a thickness of about 0.002 inch (2 mil);
3 NGR layer as described above;
4 scrim (available from Fabrene Inc.) layer composed of high density polyethylene (Sclair® HDPE No. 99G available from Nova Chemicals Corporation) and carbon black resin (Plasblack® PE1371 available from Cabot Corporation) having a thickness of about 0.004 inch (4 mil);
5 low density polyethylene (Novapol® LC-0522-A available from Nova Chemicals Canada Ltd.) tie layer containing black resin (Colortech No. 20413-19 available from Colortech Inc.) having a thickness of about 0.001 inch (1 ml);
6 active ingredient layer composed of gas black carbon (Colour Black FW200 available from Degussa Corporation), lambda cyhalothrin, and low density polyethylene (PE XU59400 or PE XU59400.00 available from The Dow Chemical Company) having a thickness of about 0.002 inch (2 mil);
7 Saranex® 14 layer as described above; and
8 NGR layer as described above.

The eight-layered sheet is formed by bonding a layer of NGR (layer 1) to a sheet of Saranex® 14 (layer 2) using an extrusion coating method to form a layer 1-2 composite. Another layer of NGR (layer 3) is melt-extruded to bond the layer 1-2 composite to a sheet of scrim (layer 4) to form a layer 1-2-3 composite. A layer of low density polyethylene (layer 5) is applied to the layer 1-2-3 composite by an extrusion coating method to form the first outer layer.

A layer 7-8 composite is prepared by applying a layer of NGR (layer 8) to a sheet of Saranex® 14 layer (layer 7) by extrusion coating.

A premix is made using the procedure of Example 10, having about 7.9% by weight of gas black carbon, 9.5% by weight of lambda cyhalothrin and the balance being a low density polyethylene. The premix is formed into active ingredient pellets using the procedure of Example 11. The active ingredient pellets are blended with low density polyethylene pellets (PE XU59400 or PE XU59400.00 available from The Dow Chemical Company) in a ratio of about 2:1 so as to achieve a concentration of about 6 wt. % of lambda cyhalothrin in the pellet mixture.

The pellet mixture is fed into an extruder to melt-extrude bond the first outer layer (i.e., layers 112, 116, 120, 122 and 126) and the second outer layer (i.e., layers 118 and 114). A multi-layered laminate sheet having an overall thickness of about 0.014 inch (14 mil) is formed. The concentration of lambda cyhalothrin in the formed laminated sheet is about 0.9 wt. %.

### Example 30

A sheet is prepared using the procedure described in Example 29 except the active layer is composed of about 4% by weight of gas black carbon (Colour Black FW200 available from Degussa Corporation), about 4.7% percent by weight of lambda cyhalothrin, and the balance of a low density polyethylene (PE XU59400 or PE XU59400 or PE XU59400.00 available from The Dow Chemical Company). The concentration of lambda cyhalothrin in the formed laminated sheet is about 0.5 wt. %.

### Examples 31-37

Sheets are prepared from premixes of lamp black carbon (Lamp black Superfine #6 available from General Carbon Company), lambda cyhalothrin, and low density polyethylene (PE XU59400 or PE XU59400.00 available from The Dow Chemical Company). The sheets are formed into laminates substantially using the procedure of Example 29, but having a final concentration of lambda cyhalothrin in the formed laminated sheet as provided in Table 7 below.

TABLE 7

| | % By Weight | | % By Weight of |
|---|---|---|---|
| | of Lamp Black | % By Weight of | Lambda cyhalothrin |
| Example | Carbon | Lambda cyhalothrin | in Laminated Sheet |
| 31 | 4 | 3.5 | 1 |
| 32 | 2 | 1.8 | 0.5 |
| 33 | 1 | 0.88 | 0.25 |
| 34 | 0.5 | 0.44 | 0.12 |
| 35 | 0.25 | 0.22 | 0.06 |
| 36 | 0.125 | 0.11 | 0.03 |
| 37 | 0.06 | 0.05 | 0.01 |

### Example 38

A six-layered sheet having the following composition was formed as follows:

Layer Description

1 New Generation Resin (NGR) (available from Fabrene, Inc.) layer composed of black resin (Colortech No. 20413-19 available from Colortech Inc.), extrusion coating grade polyolefin plastomer (Affinity® PT1450 available from The Dow Chemical Company), and low density polyethylene (Novapol® LC-0522-A available from Nova Chemicals Canada Ltd.);
2 Saranex® 14 (available from The Dow Chemical Company) layer composed of vinylidine chloride/vinyl chloride copolymer, low density polyethylene, ethylene/vinyl acetate copolymer, and silicon dioxide;
3 scrim layer composed of high density polyethylene (Sclair® HDPE No. 99G available from Nova Chemicals Corporation);
4 active ingredient layer composed of 0.91 weight percent lambda cyhalothrin in an 85 weight percent technical solution, 0.95 weight percent Lamp black #6, and 22 weight percent LDPE resin;
5 Saranex® 14 layer as described above; and
6 NGR layer as described above.

The six-layered sheet was subjected to the United States Forest Service (USFS) concrete slab methods. The concrete-slab method simulates a poured concrete foundation. To establish a test plot, leaves and debris are removed to expose soil in a square area 24 inches on a side. A 21 inch square wooden frame constructed of one inch by one inch spruce strips is placed in the center of the cleared area, and a triangular trench two inches deep and two directly on the treated soil. The PVC pipe is capped to reduce loss of moisture and to preclude rain and sunlight from affecting the termiticide.

The results of the concrete slab field trials for the following locations are shown below in Table 8.

TABLE 8

| | | % of Replicates Not Penetrated | |
|---|---|---|---|
| | | With Six-Layered | |
| Location | Termite Species | Sheet | Untreated |
| Florida (USFS) | Reticulitermes | 100 | 60 |
| | flavipes | | |
| Arizona (USFS) | Reticulitermes | 100 | 50 |
| | flavipes | | |
| Mississippi (USFS) | Reticulitermes | 100 | 100 |
| | flavipes | | |
| Malacca (Malaysia) | Globitermes | 100 | 30 |
| | sulphureus | | |

As shown in Table 8, none of the plots treated with the six-layered sheet were penetrated by termites.

While the present invention has been described with reference to one or more particular embodiments, those skilled in the art will recognize that many changes may be made thereto without departing from the spirit and scope of the present invention. Each of these embodiments and variations thereof which fall within the spirit of the invention are intended to be included within the scope of the invention defined by the following claims.

1-7. (canceled)

8. The multi-layer barrier of claim 26, wherein the pesticide is lambda cyhalothrin.

9. The multi-layer barrier of claim 26, wherein the polymeric matrix is made from low density polyethylene.

10-11. (canceled)

12. The multi-layer barrier of claim 26 further comprising at least one strength and resistance layer for providing strength and puncture resistance to the barrier.

13. The multi-layer barrier of claim 12, wherein the strength and resistance layer is made of a polymeric scrim.

14. (canceled)

15. The multi-layer barrier of claim 26, wherein the pesticide is effective against termites, wood-boring ants, and wood-boring insects.

16. The multi-layer barrier of claim 26, wherein the barrier is shaped to surround an area or a structure.

17. (canceled)

18. The multi-layer barrier of claim 26, wherein the polymeric matrix comprises a polymer and further comprises a carrier to adjust the release rate of the pesticide from the polymeric matrix.

19-25. (canceled)

26. A multi-layer barrier against wood pests comprising:
at least one continuous pesticide-releasing layer comprising a polymeric matrix, the pesticide-releasing layer containing a pesticidally effective amount of at least one pesticide for wood pests bound within the polymeric matrix; and
at least one pesticide-retaining layer positioned parallel to the pesticide-releasing layer, the pesticide-retaining layer releasing only minute amounts of the pesticide therethrough such that substantially no pesticide is released from the barrier, the release from the barrier at a rate which is less than 0.4 μg/cm²/day, the wood pests being prevented from breaching the barrier, wherein the pesticide-retaining layer comprises a coextruded multi-layered barrier film, and wherein the coextruded multi-layered barrier film consists of low density polyethylene, vinylidene chloride/vinyl chloride copolymer, ethylene/vinyl acetate copolymer, and silicon dioxide.

27-33. (canceled)

34. The barrier of claim 26, wherein the pesticide is present in an amount such that its supply is not exhausted before approximately 10 years.

35. The barrier of claim 26, wherein the pesticide is present in an amount of at least 5% by weight.

36. The barrier of claim 26, wherein the pesticide is present in an amount of at least 10% by weight.

37-38. (canceled)

39. The barrier of claim 26, wherein the pesticide is a low volatility pesticide.

40-42. (canceled)

43. The barrier of claim 18, wherein the pesticide is combined with the carrier to form a bound friable mix and the bound friable mix is added to the polymeric matrix, the carrier comprising carbon black.

44. The barrier of claim 26, wherein the pesticide is mixed with at least one fungicide.

45-76. (canceled)

77. The multi-layer barrier of claim 83, wherein the pesticide is lambda cyhalothrin.

78. The multi-layer barrier of claim 83, wherein the polymeric matrix is made from low density polyethylene.

79. The multi-layer barrier of claim 83 further comprising at least one strength and resistance layer for providing strength and puncture resistance to the barrier.

80. The multi-layer barrier of claim 79, wherein the strength and resistance layer is made of a polymeric scrim.

81. The multi-layer barrier of claim 83, wherein the pesticide is effective against termites, wood-boring ants, and wood-boring insects.

82. The multi-layer barrier of claim 83, wherein the barrier is shaped to surround an area or a structure.

83. A multi-layer barrier against wood pests comprising:
at least one continuous pesticide-releasing layer comprising a polymeric matrix, the pesticide-releasing layer containing a pesticidally effective amount of at least one pesticide for wood pests bound within the polymeric matrix; and
at least one pesticide-retaining layer positioned parallel to the pesticide-releasing layer, the pesticide-retaining layer releasing only minute amounts of the pesticide therethrough such that substantially no pesticide is released from the barrier, the release from the barrier at a rate which is less than 0.4 μg/cm²/day, the wood pests being prevented from breaching the barrier, wherein the pesticide-retaining layer comprises a coextruded multi-layered barrier film, wherein the coextruded multi-layered barrier film consists of low density polyethylene, vinylidene chloride/vinyl chloride copolymer, ethylene/vinyl acetate copolymer, and silicon dioxide,
wherein the polymeric matrix further comprises a carbon black carrier to adjust the release rate of the pesticide from the polymeric matrix.

84. The barrier of claim 83, wherein the pesticide is present in an amount such that its supply is not exhausted before approximately 10 years.

85. The barrier of claim 83, wherein the pesticide is present in an amount of at least 5% by weight.

86. The barrier of claim 83, wherein the pesticide is present in an amount of at least 10% by weight.

87. The barrier of claim 83, wherein the pesticide is a low volatility pesticide.

88. The barrier of claim 83, wherein the pesticide is mixed with at least one fungicide.

89. The multi-layer barrier of claim 98, wherein the pesticide is selected from pyrethroids, isofenphos, fenvalerate, pyrethrin, and combinations thereof.

90. The multi-layer barrier of claim 98, wherein the pesticide is selected from tefluthrin, permethrin, lambda cyhalothrin, deltamethrin, cypermethrin, cyfluthrin, and combinations thereof.

91. The multi-layer barrier of claim 98, wherein the pesticide is lambda cyhalothrin.

92. The multi-layer barrier of claim 98, wherein the polymeric matrix is made from low density polyethylene.

93. The multi-layer barrier of claim 98 further comprising at least one strength and resistance layer for providing strength and puncture resistance to the barrier.

94. The multi-layer barrier of claim 93, wherein the strength and resistance layer is made of a polymeric scrim.

95. The multi-layer barrier of claim 98, wherein the pesticide is effective against termites, wood-boring ants, and wood-boring insects.

96. The multi-layer barrier of claim 98, wherein the barrier is shaped to surround an area or a structure.

97. The multi-layer barrier of claim 98, wherein the polymeric matrix comprises a polymer and further comprises a carrier to adjust the release rate of the pesticide from the polymeric matrix.

98. A multi-layer barrier against wood pests comprising:
at least one continuous pesticide-releasing layer comprising a polymeric matrix, the pesticide-releasing layer containing a pesticidally effective amount of at least one pesticide for wood pests bound within the polymeric matrix; and
at least one pesticide-retaining layer positioned parallel to the pesticide-releasing layer, the pesticide-retaining layer releasing only minute amounts of the pesticide therethrough such that substantially no pesticide is released from the barrier, the wood pests being prevented from breaching the barrier, wherein the pesticide-retaining layer comprises a coextruded multi-layered barrier film, wherein the coextruded multi-layered barrier film consists of low density polyethylene, vinylidene chloride/vinyl chloride copolymer, ethylene/vinyl acetate copolymer, and silicon dioxide.

99. The barrier of claim 98, wherein the pesticide is present in an amount of at least 5% by weight.

100. The barrier of claim 98, wherein the pesticide is present in an amount of at least 10% by weight.

101. The barrier of claim 98, wherein the pesticide is a low volatility pesticide.

102. The barrier of claim 97, wherein the pesticide is combined with the carrier to form a bound friable mix and the bound friable mix is added to the polymeric matrix, the carrier comprising carbon black.

103. The barrier of claim 98, wherein the pesticide is mixed with at least one fungicide.

104. The multi-layer barrier of claim 112, wherein the pesticide is selected from pyrethroids, isofenphos, fenvalerate, pyrethrin, and combinations thereof.

105. The multi-layer barrier of claim 112, wherein the pesticide is selected from tefluthrin, permethrin, lambda cyhalothrin, deltamethrin, cypermethrin, cyfluthrin, and combinations thereof.

106. The multi-layer barrier of claim 112, wherein the pesticide is lambda cyhalothrin.

107. The multi-layer barrier of claim 112, wherein the polymeric matrix is made from low density polyethylene.

108. The multi-layer barrier of claim 112 further comprising at least one strength and resistance layer for providing strength and puncture resistance to the barrier.

109. The multi-layer barrier of claim 108, wherein the strength and resistance layer is made of a polymeric scrim.

110. The multi-layer barrier of claim 112, wherein the pesticide is effective against termites, wood-boring ants, and wood-boring insects.

111. The multi-layer barrier of claim 112, wherein the barrier is shaped to surround an area or a structure.

112. A multi-layer barrier against wood pests comprising:
at least one continuous pesticide-releasing layer comprising a polymeric matrix, the pesticide-releasing layer containing a pesticidally effective amount of at least one pesticide for wood pests bound within the polymeric matrix; and
at least one pesticide-retaining layer positioned parallel to the pesticide-releasing layer, the pesticide-retaining layer releasing only minute amounts of the pesticide therethrough such that substantially no pesticide is released from the barrier, the wood pests being prevented from breaching the barrier, wherein the pesticide-retaining layer comprises a coextruded multi-layered barrier film, wherein the coextruded multi-layered barrier film consists of low density polyethylene, vinylidene chloride/vinyl chloride copolymer, ethylene/vinyl acetate copolymer, and silicon dioxide,
wherein the polymeric matrix further comprises a carbon black carrier to adjust the release rate of the pesticide from the polymeric matrix.

113. The barrier of claim 112, wherein the pesticide is present in an amount of at least 5% by weight.

114. The barrier of claim 112, wherein the pesticide is present in an amount of at least 10% by weight.

115. The barrier of claim 112, wherein the pesticide is a low volatility pesticide.

116. The barrier of claim 112, wherein the pesticide is mixed with at least one fungicide.
